(19) United States
(12) Patent Application Publication
(10) Pub. No.: US 2015/0304268 A1
(43) Pub. Date: Oct. 22, 2015

(54) SHARING A SECRET IN A SOCIAL NETWORKING APPLICATION ANONYMOUSLY

(71) Applicant: Secret, Inc., San Francisco, CA (US)

(72) Inventors: David Byttow, San Francisco, CA (US); Christopher Bader-Wechseler, San Francisco, CA (US)

(21) Appl. No.: 14/476,558

(22) Filed: Sep. 3, 2014

Related U.S. Application Data
(63) Continuation of application No. 14/278,270, filed on May 15, 2014.
Application No. 14/278,270 is a continuation-in-part of application No. 14/264,946, filed on Apr. 29, 2014, now Pat. No. 8,862,679.
(60) Provisional application No. 61/981,736, filed on Apr. 18, 2014.

(51) Int. Cl. H04L 12/58; G06Q 50/00

(52) U.S. Cl. CPC H04L 51/32; G06Q 50/01

(57) ABSTRACT

Technology is directed to a social networking application for sharing secrets anonymously. The social networking application receives a message from a user, anonymizes the message to generate a secret and shares the secret with other users. The other users cannot know who posted the secret. A message can include multimedia content such as a text, an image, an audio, a video or a combination thereof. The secrets are displayed in a graphical user interface (GUI) as secret GUI components. A secret GUI component displays the secret in a particular format. In one example, a text of the secret is superimposed on an image or a background color of the secret in the secret GUI component. The secret GUI component includes GUI elements using which users can “love”/“heart”/“like” a secret and/or comment on the secret. The secret GUI component can display author-viewer relationship information or a location information of the author.

### CROSS-REFERENCE TO RELATED APPLICATION(S)

This application is a continuation of U.S. patent application Ser. No. 14/278,270, entitled “SHARING A SECRET IN A SOCIAL NETWORKING APPLICATION ANONYMOUSLY”, filed on May 15, 2014, which is a continuation-in-part of U.S. patent application Ser. No. 14/264,946, entitled “DISPLAYING COMMENTS ON A SECRET IN AN ANONYMOUS SOCIAL NETWORKING APPLICATION”, filed on Apr. 29, 2014, which claims the benefit of U.S. Provisional Patent Application No. 61/981,736, entitled “SHARING A SECRET IN A SOCIAL NETWORKING APPLICATION ANONYMOUSLY”, filed on Apr. 18, 2014, which is incorporated by reference herein in its entirety.

### TECHNICAL FIELD

At least one embodiment of the technique introduced here relates to a social networking application, and more particularly, to sharing a secret in the social networking application anonymously.

### BACKGROUND

As social networking has become universal, people have become increasingly sensitive to what they share online. Speaking on a stage in front of a mixed audience of family, friends, and acquaintances makes it hard for the people to be their most authentic selves. As a result, people tend to share only their proudest moments in an attempt to portray their best selves. They often filter too much, and with that, may lose real human connection. People are not free to express themselves without holding back. It's not only speaking on a stage that's hard, it's also difficult choosing when to like, comment, and re-share other people's posts. Sometimes showing approval of controversial content can be embarrassing or intimidating.

Current social networking applications typically require the user to identify themselves. Every action of the user has a bearing on the image or the reputation of the user. As one's social networking applications becomes saturated, the person can feel very public. It puts the focus on managing the person's image, rather than truly bonding with people.

In this day and age, privacy and security are more important than ever. Most of the social networking applications upload the address book to connect the user with their friends. They also store the data as they have to match new friends that join the service long after you've uploaded your address book. But, even if a service doesn't store the contact information in a database, there are all sorts of other places it can go, such as into the logs that nearly all services keep for debug and analytical purposes. The data is there and it's discoverable, and therefore may lack privacy and security.

### BRIEF DESCRIPTION OF THE DRAWINGS

FIG. 1 is a block diagram illustrating an environment in which a social networking application for sharing secrets can be implemented.

FIG. 2 is an example graphical user interface (GUI) for displaying a secret.

FIG. 3A is a block diagram of a representation of contact information of a user and contacts of the user.

FIG. 3B is an example illustrating a graph for determining friends and friends of friends of a user in the social networking application.

FIG. 4 is a flow diagram of a process for sharing secrets between users in the social networking application.

FIG. 5 is a flow diagram of a process for delivering secrets to a user.

FIG. 6 is a flow diagram of a process for propagating an existing secret to the users in the social networking application.

FIG. 7 is a flow diagram of a process for generating a friends graph object having a list of friends of a user.

FIG. 8, which includes FIGS. 8A, 8B, 8C and 8D, is an example of GUIs for posting a secret to the social networking application of FIG. 1.

FIG. 9 is an example GUI for displaying a secret and comments posted on the secret.

FIG. 10 is an example GUI for displaying comments posted on a secret of FIG. 9.

FIGS. 11A and 11B illustrate an example of a user interaction performed on a GUI of FIG. 9.

FIGS. 12A, 12B and 12C illustrate an example of another user interaction performed on the GUI of FIG. 9.

FIG. 13 is a block diagram of the server for facilitating displaying comments associated with a secret at a computing device of a user.

FIG. 14 is a block diagram of a computing device for generating a GUI to share a secret and comments on the secret with users of the social networking application.

FIG. 15 is a flow diagram of a process for generating a GUI at a computing device for displaying secrets posted in a social networking application.

FIG. 16 is a flow diagram of a process for sharing a set of secrets with a user in the social networking application.

FIG. 17 is a flow diagram of a process for displaying comments posted on a secret in the social networking application.

FIG. 18 is a flow diagram of a process for generating a GUI for displaying a secret and comments posted on the secret in the social networking application.

FIGS. 19A, 19B and 19C are example GUIs illustrating a swipe user interaction for liking a secret.

FIG. 20 is a block diagram of a computer system as may be used to implement features of some embodiments of the disclosed technology.

### DETAILED DESCRIPTION

Introduced here is a technology for sharing secrets in a social networking application anonymously (“the technology”). A user can share messages with other users of the social networking application anonymously. The social networking application receives a message from a user, anonymizes the message to generate a secret and shares the secret with other users. The other users may not know who posted the secret (i.e., a message corresponding to the secret). A message can include multimedia content such as a text, an image, an audio, a video or a combination thereof. In some embodiments, a secret is a message that is devoid of any user identification information that can distinctly identify a user who posted the secret, liked and/or commented on the secret. In some embodiments, the user identification information that can distinctly identify a user includes a username of the user, an image of the user, contact information of the user, or any other information that enables other users to distinctly identify the user who posted the secret.

In some embodiments, the secret includes general identification information, such as a location of an author of the secret and/or a relationship between an author of the secret and a particular user. However, the general identification information does not include any information that can (a) distinctly identify the author of the secret or (b) be used to derive the user identification information of the author.

The secrets are displayed in a graphical user interface (GUI) generated at a computing device, e.g., a smartphone. The GUI displays the secrets as a number of secret GUI components. In some embodiments, the secret GUI components are of substantially the same shape and dimension. A secret GUI component displays a secret in a particular format. In one example, a text of the secret is superimposed on an image or a background color of the secret in the secret GUI component. The secret GUI component can display author-viewer relationship information or location information of the author of the secret.

The secret GUI component includes GUI elements using which users can “love”/“heart”/“like” a secret and/or comment on the secret. A user can “love”/“heart”/“like” a secret to indicate that the user likes the secret. The social networking application assigns a unique avatar to each of the users who comment on a secret. In some embodiments, the avatars are assigned on random basis. An author of the secret is assigned a specific avatar. In some embodiments, authors of any of the secrets are assigned the same specific avatar. Each of the comments is displayed with an avatar assigned to the user who posted the corresponding comment. The avatars can also be assigned based on a theme, occasion, etc.

Users can further share the secret on other social networking applications, e.g., Facebook, Twitter. Like for the user who posts a secret, anonymity is maintained for other users in the social networking application, including users who love and/or comment on the secret.

A secret from a user is delivered to a selected set of users, e.g., friends of the user. A delivery mechanism determines who the friends of the users are and shares the secret with some or all of the friends of the user. In some embodiments, the friends of a user are a set of individuals in the contacts list of the user, e.g., an address book of the user, who are also members of the social networking application. A friend to whom the secret is delivered is determined as a function of various factors, including one or more of number of comments made by the friend, a number of hearts the friend has given, a number of hearts the secret has received, a reputation of the friend, a time of the day, whether the friend is blocked by the user, a geographical location of the friend, etc.

Note that hereinafter, the phrases “love a secret,” “like a secret” or “heart a secret” or variations of them are used interchangeably. The terms “user device” and “computing device” are used interchangeably and unless stated otherwise they refer to a computing device that is capable of executing the social networking application described in the document and facilitating the users of the social networking application to compose, view and/or share the secrets. Note that the term “user identification information” is used to include any identification information that can distinctly identify a user, e.g., a username of the user, an image of the user, contact information of the user, or any other information that enables other users to distinctly identify a user who posted/commented/liked the secret. Note that the term “general identification information” is used to indicate identification information, such as a location information which can indicate a location of an author of a secret and/or a relationship information which can indicate a relationship between the author and a particular user. However, the general identification information does not include any information that can (a) distinctly identify the author of the secret or (b) be used to derive the user identification information of the author.

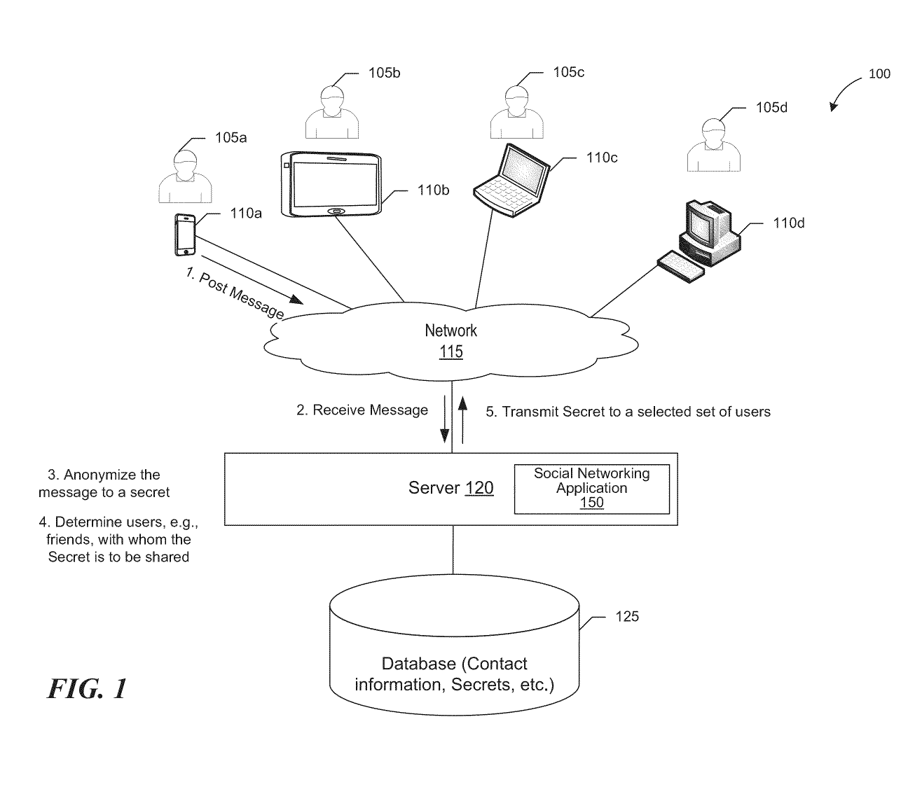

FIG. 1 is a block diagram illustrating an environment 100 in which a social networking application for sharing secrets can be implemented. The environment 100 includes a server 120 on which a social networking application 150 that facilitates sharing secrets between a number of users, e.g., users 105a-d, is executing. In some embodiments, a portion of the social networking application 150, e.g., a server portion, executes on the server 120 and another portion of the social networking application 150, e.g., a client portion, executes on the user device. The social networking application 150 can be implemented in various configurations. For example, the social networking application 150 can be implemented as an online service which can be accessed by users via an application such as a web browser. In another example, the social networking application 150 can be implemented as a downloadable application, e.g., a mobile application, that can be executed on user devices 110a-d. In some embodiments, the downloaded mobile application can be the client portion of the social networking application 150.

The user devices 110a-d can be a computing device such as a smartphone, tablet, laptop, desktop, wearable electronic gadgets, automobiles with integrated computing devices, etc. The user devices 110a-d can be any computing device that is capable of providing users access to the social networking application 150. The user devices communicate with the server over a network 115, such as Internet, local area network (LAN), wireless LAN, wide area network (WAN) etc.

A user, such as user 105a, posts a message to the social networking application 150, e.g., using the mobile application executing on the user device 110a. The message can include data such as text, audio, video, an image, animation, etc. The server 120 receives the message from the user 105a and anonymizes the message to generate a secret. In some embodiments, anonymizing the message to generate a secret includes removing from the message any user identification information that reveals an identity of the user or distinctly identifies the user from among the other users. The server 120 determines a list of friends or followers of the user 105a to whom the secret should be delivered. After the list of friends is determined, the server 120 posts the secret to some or all of the friends from the list.

The friends, who receive the secret, can view the secret, e.g., on news feed of the social networking application 150. In some embodiments, a news feed is a portion of the graphical user interface (GUI) of the social networking application 150 where the users 105a-d can view the secrets shared by the user 105a and/or other users. The secrets are shared between the users 105a-d anonymously. The anonymity is maintained for all the users, e.g., a user who posts the secret, comments on the secret and/or loves the secret.

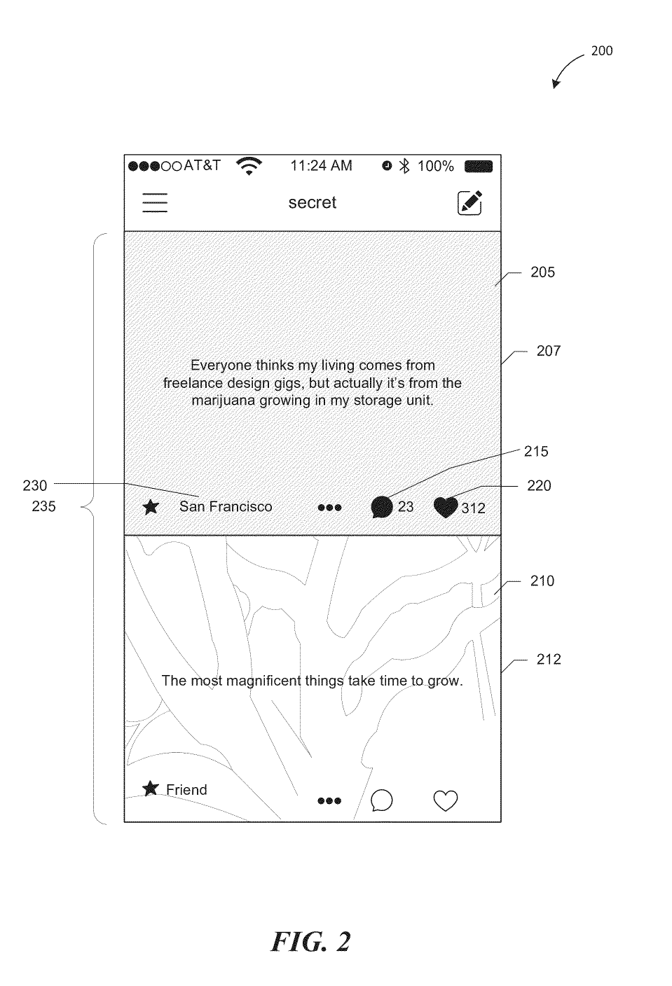

FIG. 2 is an example first GUI 200 for displaying a secret. The first GUI 200 displays a number of secrets, such as a first secret 205 and a second secret 210 shared by one or more users, such as users 105a-d. The user 105a can view the first GUI 200 on the user device 110a. The first secret 205 includes text that reads as “Everyone thinks my living comes from freelance design gigs, but actually it's from the marijuana growing in my storage unit.” The user 105a may view more secrets by scrolling the news feed 235. A secret can have a colored background or an image background. Note that the first secret 205 has a colored background and the second secret 210 has an image background.

In some embodiments, the first GUI 200 displays the secrets using a number of secret GUI components, such as a first secret GUI component 207 and a second secret GUI component 212. The first secret GUI component 207 displays the first secret 205 and the second secret GUI component displays 212 the second secret 210. A secret GUI component displays the secret in a particular format. For example, the secret GUI component superimposes a text of the secret on an image or a background color in the secret GUI component. The text and the image or the background color is input by the author of the secret, e.g., as part of composing a secret. As illustrated in FIG. 2, the first secret GUI component 207 has superimposed a text of the first secret 205 on the background color (e.g., indicated by shading in the first secret GUI component 207) associated with the first secret 205. Similarly, the second secret GUI component 212 has superimposed a text of the second secret 210 on the image associated with the second secret 210. The background color and/or the image can occupy an entire area of the secret GUI component or only a portion thereof. In some embodiments, the background color and/or the image occupies an entire area of the secret GUI component.

The first GUI 200 generates the secret GUI components as a scrollable list in the news feed 235. The user may scroll the news feed 235 to view more secret GUI components. The secret GUI components can be generated in various patterns. For example, the secret GUI components can be generated in random shapes and dimensions. In another example, some secret GUI components, e.g., alternate secret GUI components in the news feed 235, can be generated in same shapes and dimensions. For example, each of the secret GUI components can be generated as a rectangle shaped component having the same dimensions, e.g., width and height. In another example, each of the secret GUI components can be generated as a square shaped component having the same dimensions. As illustrated in FIG. 2, the first secret GUI component 207 and the second secret GUI component 212 are generated as rectangle shaped components with substantially same dimensions. In some embodiments, the secret GUI components are generated in substantially same shape and dimension. In some embodiments, the secret GUI components are considered to be substantially of the same dimension if the secret GUI components appear to be of the same dimensions to a human eye.

Each of the secret GUI components displayed in the news feed 235 includes a comment GUI element. In some embodiments, the comment GUI element facilitates the user 105a to comment on a secret displayed in the secret GUI component. For example, the comment GUI element 215 can facilitate the user 105a to comment on the first secret 205. In some embodiments, the comment GUI element 215 allows the user 105a to comment on the first secret 205 if the user 105a is a friend of the author of the first secret 205. The comment GUI element can also indicate the number of comments received for a secret displayed in the secret GUI component. For example, the comment GUI element 215 displayed in the first secret GUI component 207 indicates that the first secret 205 has received twenty three “23” comments. If a particular secret has not received any comments, the secret GUI component may not display any number in association with the comment GUI element, e.g., as illustrated in second secret GUI component 212. Further, if there are no comments on a secret yet, the secret GUI component can display the comment GUI element in a format different from that of displayed for the secrets that have comments. For example, as illustrated in FIG. 2, the comment GUI element 215 is displayed with a fill color and the comment GUI element in second secret GUI component 212 is displayed without a fill color.

Each of the secret GUI components displayed in the news feed 235 includes a heart GUI element. The heart GUI element facilitates the user to “like” the secret indicating that the user likes the secret. For example, the heart GUI element 220 in the first secret component facilitates the user to “like” the first secret 205. The heart GUI element can also indicate the number of “likes” received for a secret displayed in the secret GUI component. For example, the heart GUI element 220 displayed indicates that the first secret 205 has received three hundred and twelve (“312”) “likes.” In some embodiments, while only a friend of a user can comment on a particular secret posted by the user, any user with whom the particular secret is shared can “like” the particular secret. If a particular secret has not received any “likes,” the secret GUI component may not display any number in association with the heart GUI element, e.g., as illustrated in second secret GUI component 212.

Further, if there are no “likes” on a secret yet, the secret GUI component can display the heart GUI element in a format different from that of displayed for the secrets that have received “likes.” For example, as illustrated in FIG. 2, the heart GUI element 220 is displayed with a fill color and the heart GUI element in second secret GUI component 212 is displayed without a fill color. Further, in some embodiments, when a user “likes” a secret, the heart GUI element may be displayed a specific format indicating that the user “likes” the secret. For example, if the user 105a “likes” the first secret 205, the heart GUI element 220 may be displayed with a fill color such as red, indicating that the user 105a liked the secret. Further, such a representation of the heart GUI element 220, e.g., a red fill color, may be presented only to the user 105a who liked the secret. That is, if the user 105a liked the first secret 205, only the user 105a may see the red colored heart and not the other users.

In some embodiments, each of the secret GUI components can include an identification tag that indicates general identification information of the author of the corresponding secret. In some embodiments, the identification tag can display location information which indicates a location of the author of the secret. For example, the identification tag 230 displays information regarding a location of the author of the first secret 205. In some embodiments, the identification tag can display relationship information, which indicates a relationship between the author of a secret and the user, e.g., user 105a who is viewing the secret on the user device 110a. For example, the identification tag in the second secret GUI component 212 displays information regarding a relationship between the author of the second secret 210 and the user 105a.

In some embodiments, the relationship information indicates a degree of relationship between the author of a secret and a user, e.g., user 105a. For example, if user “A” is a friend of user “B,” then users “A” and “B” are considered to share a first degree relationship. For example, if user “A” is a friend of user “B” and user “B” is a friend of user “C”, that is, user “C” is a friend of friend (“FoF”) of user “A”, then users “A” and “C” are considered to share a second degree relationship. Any relationship beyond the second degree relationship (e.g., neither a friend nor a FoF) can be considered as multi-degree relationship. The relationship information displayed can include information such as “Friend,” “Friend of Friend,” “Your Circle.” In some embodiments, the identification tag of a secret having relationship information “Friend” indicates that the secret is posted by a friend of the user 105a. In some embodiments, the identification tag of secret having relationship information “Friend of Friend” indicates that the secret is posted by a FoF of the user 105a. In some embodiments, the identification tag of a secret having relationship information “Your Circle” indicates that the secret is posted by a friend or a FoF of the user 105a. The above relationship information displayed in the identification tags are just examples. The identification tag can display the relationship information using various other words and phrases.

The location information displayed can be information such as a city, e.g., San Francisco, a state, e.g., California, a country, a distance of the author of the secret from the user 105a, e.g., 2.5 miles, etc. As illustrated in FIG. 2, the first secret GUI component 207 displays the identification tag 230 that indicates a city of the author of the first secret 205.

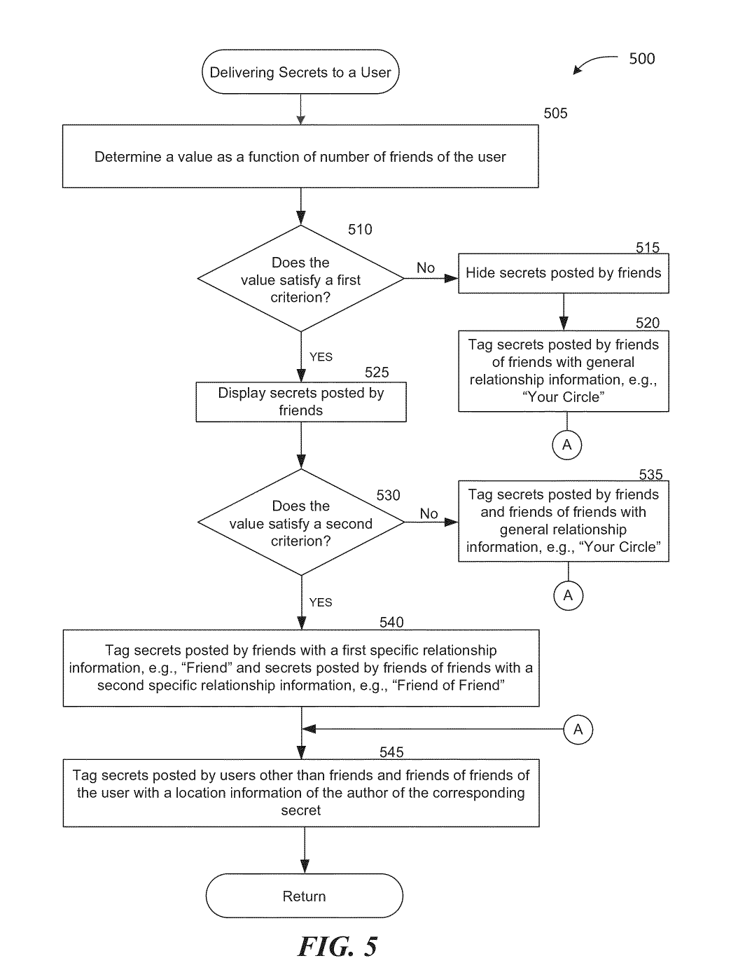

The information to be displayed in the identification tag is determined based on various factors, e.g., a number of friends the user 105a has in the social networking application 150 or a degree of relationship between the author of the secret and the user 105a. For example, if the number of friends the user 105a has is below a particular threshold, the identification tag is displayed as “Your Circle” regardless of whether the secrets are posted by friends or friends of friends of the user 105a. In another example, if a particular secret is posted by users other than a friend or a FoF of the user 105a (e.g., users who do not share either a first degree or a second degree relationship with the user 105a) the identification tag displays the location of the author of the particular secret. Additional details with respect to identification tags are described at least with reference to FIG. 5.

Referring back to FIG. 1, a delivery mechanism of the social networking application 150 determines who the friends/followers of a user, e.g., user 105a, are and shares the secret posted by the user 105a with some or all of the friends of the user 105a. In some embodiments, the friends of the user 105a are individuals (also referred to as “contacts”) in a contacts list of the user 105a, e.g., an address book of the user 105a, who are also members of the social networking application 150. In some embodiments, the address book is stored on the user device 110a. In some embodiments, the address book is a third party application or service used by the user 105a to store contact information of an entity, e.g., a person. When the user 105a signs up for the social networking application 150, contact information of the user 105a and the contacts in the address book of the user 105a are uploaded to the server 120. In some embodiments, the contact information includes a phone number and/or an email ID of an entity. The contact information of the contacts may be hashed locally before uploading to the server 120 so that the contacts are anonymous to the server 120. The hashing may be performed using a salt. In cryptography, a salt is random data that is used as an additional input to a one-way function that hashes data, e.g., password or passphrase.

In some embodiments, the function of a salt is to defend against dictionary attacks and pre-computed rainbow table attacks. A new salt can be randomly generated for contact information of each contact. When the contact information is hashed with the salt, a phone number such as [+15552786005] can become hashed data such as [a22d75c92a630725f4] and the hashed data is sent to the server 120. The original phone number of the contact may not be uploaded from the user device. While only hashed data of the contact information of the contacts of the user 105a is uploaded to the server 120, the contact information of the user 105a may be uploaded in both hashed and non-hashed format.

The communication between the user devices 110a-d and the server 120 can be secured using a secure communication protocol. In some embodiments, the user devices 110a-d transmit the contact information to the server 120 using a cryptographic protocol such as secure socket layer (SSL).

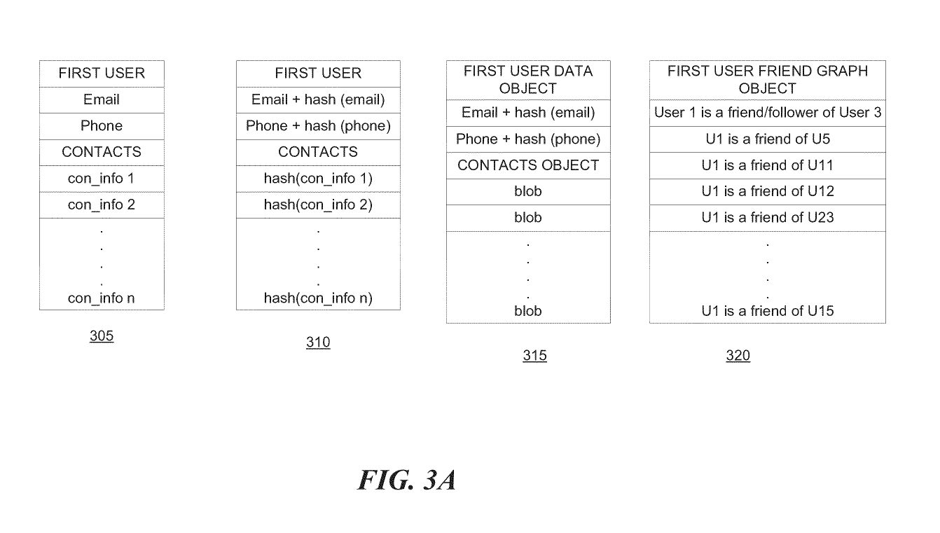

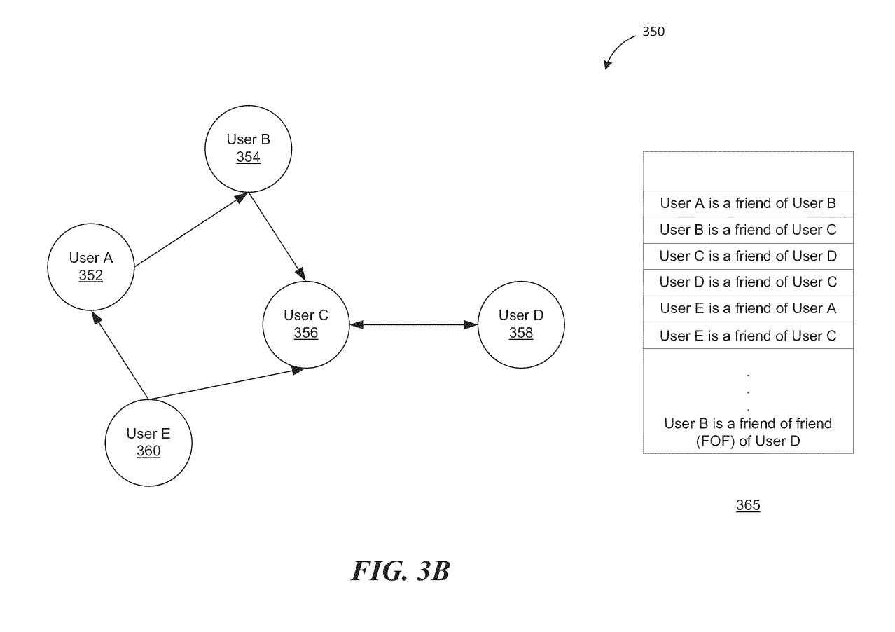

FIG. 3A illustrates a block diagram of a representation of contact information of a new user, such as user 105a, and the contacts of the user 105a. The contact object container 305 represents the contact details of the user 105a and the contacts of the user 105a as stored on the computing device 110a. A client portion of the social networking application 150, e.g., social networking app, executing on the computing device 110a hashes the contact information of the user 105a and the contacts of the user 105a as illustrated by hashed object container 310. The client portion then transmits the hashed object container 310 to the server 120.

After the server 120 receives the contact information of the user 105a and the contacts of the user 105a in the address book, the server 120 stores the contact information as a user data object, e.g., as illustrated by user data object 315. The user data object 315 stores the contact information of the user 105a in both hashed and non-hashed format as shown in FIG. 2. The user data object 315 stores the contact information of the contacts of the user 105a in a contact data object. The contact data object stores the contact information of each of the contacts of the user 105a as hashed data. In some embodiments, the server 120 stores the hashed data of the contacts as binary large objects (“BLOBs”). The user data object 315 may be stored in a storage medium 125 associated with the server 120, e.g., as a database. The client portion of the social networking application 150 performs the process of uploading the contact information of the users 105a-d and the users' contacts, and creating a user data object for each of the users 105a-d who sign up with the social networking application 150.

When the user 105a signs up with the social networking application 150, the server 120 determines if any of the contacts of the user 105a are also in the social networking application 150. The server 120 compares the hashed data of the contact information of each of the contacts of the user 105a with hashed contact information of all other users who have signed up with the social networking application 150 to determine if there is any match. If there is a match between hashed contact information of a first contact of the user 105a and the hashed information of a first user in a user data object corresponding to the first user, then the server 120 determines that the user 105a is “a friend of” or “a follower of” the first contact in the social networking application 150. However, if the first contact does not have the contact information of the user 105a in his/her contacts list, then the first contact is not a follower of user 105a. After identifying all the friends of the user 105a, the server 120 generates a friend graph object containing the hashed data of the contact information of the friends of the user 105a, e.g., as illustrated by friend graph object 320. The server 120 generates a friend graph object for each of the users in the social networking application 150.

FIG. 3B is an example illustrating a graph 350 for determining friends and friends of friends of a user in the social networking application 150. In some embodiments, the graph 350 and the table 365 may be determined by the server 120 using the objects described with reference to FIG. 3A. In the graph 350, user A 352, user B 354, user C 356, user D 358 and user E 360 are users of the social networking application 150. As indicated by table 365, the user A 352 is considered as a friend or a follower of user B 354 since user A 352 has user B 354 in his/her address book. However, the user B 354 is not considered as a friend or a follower of user A 352 since user B 354 does not have user A 352 in his/her address book. With respect to users, user C 356 and user D 358, they are considered to be friends or followers of each other as each of them has the other user in their address book.

User B 354 is a FoF of user D 358 since user B 354 is a friend user C 356 who is a friend of user D 358. All friends are connected directly and are considered to share a first degree relationship. The FoFs have two degrees of separation and are considered to share a second degree relationship. All relationships beyond two degrees of separation, e.g., friend of FoF (“FoFoF”), are considered to share multi-degree relationship. In the graph 350, the users, user A 352 and user D 358 share a multi-degree relationship.

Referring back to the delivery mechanism for the secrets, when the user 105a posts a secret, the server 120 determines a list of friends of the user 105a, e.g., using the friend graph object 320. The server 120 may then send the secret to the friends of the user 105a. In some embodiments, the server 120 may send the secret to a subset of the friends of the user 105a. The server 120 determines the subset of friends as a function of various propagation factors, including one or more of a number of friends the friend has, a number of comments made by the friend, a number of hearts the secret has received, a reputation of the friend, a time of the day, whether the friend has blocked the user, whether the friend is blocked by the user, a geographical location of the friend, a number of hearts received on a particular secret posted by a friend, etc. After the subset of friends is determined, the server 120 transmits the secret to the subset of the friends. The friends may then see the secret on the news feed of the social networking application 150.

Further, the secret can be sent to different friends at different times. For example, a secret posted by the user 105a may not be shared with a particular friend of the user 105a until the secret has received a predetermined number of “likes” or until the particular friend has posted a predetermined number of secrets, etc. In another example, the time when the secret is sent to/shared with a particular friend can also depend on the reputation of the particular friend.

Also, the secret can be propagated to a FoF of the user. For example, when a friend of the user 105a likes or hearts a secret posted by the user 105a, the secret may also be propagated to a FoF of the user 105a. As with friends, the FoFs to whom the secret is to be transmitted is determined as a function of various propagation factors.

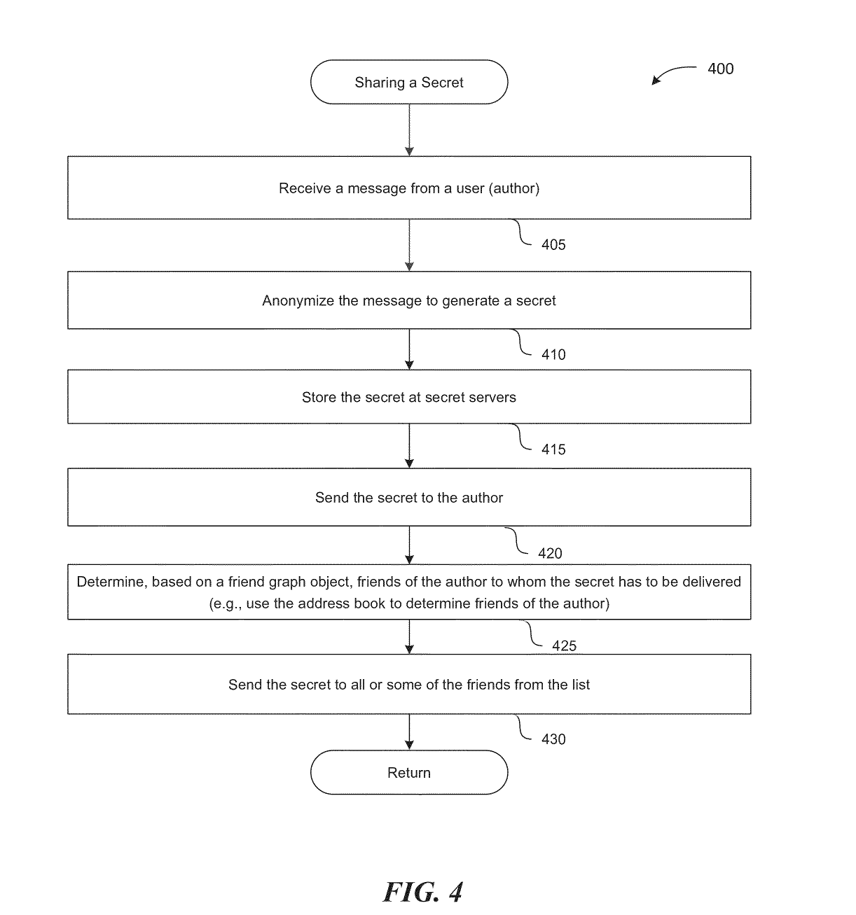

FIG. 4 is a flow diagram of a process 400 for sharing secrets in the social networking application 150. In some embodiment, the process 400 may be performed in the environment of FIG. 1. At step 405, the social networking application 150 receives a message from a user that has to be posted as a secret in the social networking application 150. A user who composes a message of a secret is also referred to as an author of the secret. The author may input the message to the social networking application 150 in various ways. For example, the author may input the message of the secret using the client portion, such as a mobile application, of the social networking application 150. In another example, the author may input the message of the secret by emailing, tweeting, or texting into the social networking application 150. In yet another example, the author may input the message of the secret by posting the message to the social networking application 150 from a third party application. The third party application may transmit the message of the secret to the social networking application 150 via an application programming interface (API) provided by the social networking application 150.

At step 410, the server 120 anonymizes the message. In some embodiments, anonymizing the message can include isolating user identification information of the user who posted the message from the message. The server 120 may extract the user identification information from the message and then deliver the message without the user information, e.g., as a secret. The server 120 can store the user identification information associated with the secret separate from the secret on the database. In some embodiments, a user has the option to delink himself/herself from the secret the user has posted, in which case an author of the secret may not be discoverable by any entity, including the social networking application 150.

At step 415, the server 120 stores the secret at the storage medium 125, e.g., in a database. At step 420, the server 120 transmits the secret to the author. The author can view the secret on the news feed of the social networking application 150. At step 425, the server 120 determines the friends of the author to whom the secret has to be delivered, e.g., as described above at least with reference to FIG. 1, FIGS. 3A and 3B.

At step 430, the server 120 transmits the secret to at least some of the friends of the author. The friends may then see the secret on the news feed of the social networking application 150. In some embodiments, the server 120 determines a subset of the friends to whom the secret is to be delivered as a function of the various propagation factors as described above at least with reference to FIGS. 1 and 3A. The secret can also be propagated to a FoF of the author. Further, the secret can be sent to different friends at different times.

For example, consider that a user C 352 posts a secret. The server 120 determines that the friends of the user C 356 are user B 354, user D 358 and user E 360. The server 120 may determine that the reputation of user B 354 is the best among the friends of the user C 325, and therefore may transmit the secret to user B 354 immediately. The server 120 may determine that the user C 356 has blocked user D 358 and therefore, may not transmit the secret to the user D 358. With respect to user E 360, the server 120 may determine to transmit the secret after the secret receives a predetermined number of “likes”. Also, the secret can be propagated to a FoF of the user C 356. For example, when a friend of the user C 356, e.g., user B 354, likes the secret posted by user C 356, the server 120 may propagate the secret to a friend of the user B 354, e.g., user A 352.

FIG. 5 is a flow diagram of a process 500 for delivering secrets to a user. The process 500 can be executed in the environment 100. In some embodiments, the server 120 determines the set of secrets to be transmitted to the user (which are then displayed on a user device associated with the user) as a function of a number of friends the user has. At step 505, the server 120 determines a value as a function of the number of friends of the user. At determination step 510, the server 120 determines whether the value satisfies a first criterion. Responsive to a determination that the value does not satisfy the first criterion, at step 515, the server 120 does not transmit some of the secrets to the user. For example, if the number of friends the user has is lesser than a first threshold, the server 120 may not transmit the secrets posted by the friends of the user to the user. The server 120 transmits secrets that are posted by users other than the friends of the user, including a FoF of the user. In some embodiments, the fewer “friends” a user has on the social networking application 150, the lesser is the number of secrets displayed to the user. In some embodiments, this is done to avoid simple tricks to isolate individuals and their secrets, e.g., to maintain anonymity of the friend who has posted a particular secret. In some embodiments, the chances of the user identifying the friend who posted the particular secret is higher if the user has less number of friends in the social networking application. For example, if the user has only one friend (e.g., only one contact from his/her address book on the social networking application), and if the particular secret posted by the friend is displayed to the user with the identification tag “Friend”, the user can easily determine who that friend is, thereby causing the anonymity of the friend to be lost.

At step 520, the identification tag displayed in association with the secrets posted by the FoFs of the user can include general relationship information, such as “Your Circle,” which indicates that the secret is from a friend or FoF the user. The general relationship information displayed is such that the user may not know whether a friend of the user or a FoF of the user has posted the secret. The process 500 then proceeds to step 545.

Referring back to determination step 510, if the value satisfies the first criterion, at step 525, the server 120 transmits the secrets posted by the friends of the user as well as by FoFs of the user. For example, if the number of friends the user has is equal to or more than the first threshold, the server 120 transmits the secrets posted by the friends of the user and FoFs of the user.

At determination step 530, the server 120 determines whether the value satisfies a second criterion. If the value does not satisfy the second criterion, at step 535, the identification tag displayed in association with the secrets of the friends of the user or the friends of friends of the user can include relationship information, such as “Your Circle.” For example, if the number of friends the user has is more than the first threshold but lesser than a second threshold, the identification tag displayed in association with the secrets posted by the friends of the user or the friends of friends of the user can include general relationship information, such as “Your Circle.” The user may not know whether the secret is from a friend of the user or a FoF of the user.

On the other hand, if the value satisfies the second criterion, at step 540, the identification tag associated with the secrets can indicate whether a particular secret is from a “Friend” or “Friend of Friend” of the user.

At step 545, the identification tag associated with the secrets that are posted by users other than a friend or a FoF of the user can indicate a location of the author of the corresponding secret.

However, regardless of whether the secrets are posted by a friend of the user, a FoF of the user or other users, the social networking application 150 does not reveal user identification information of the author of the secret at any point in time.

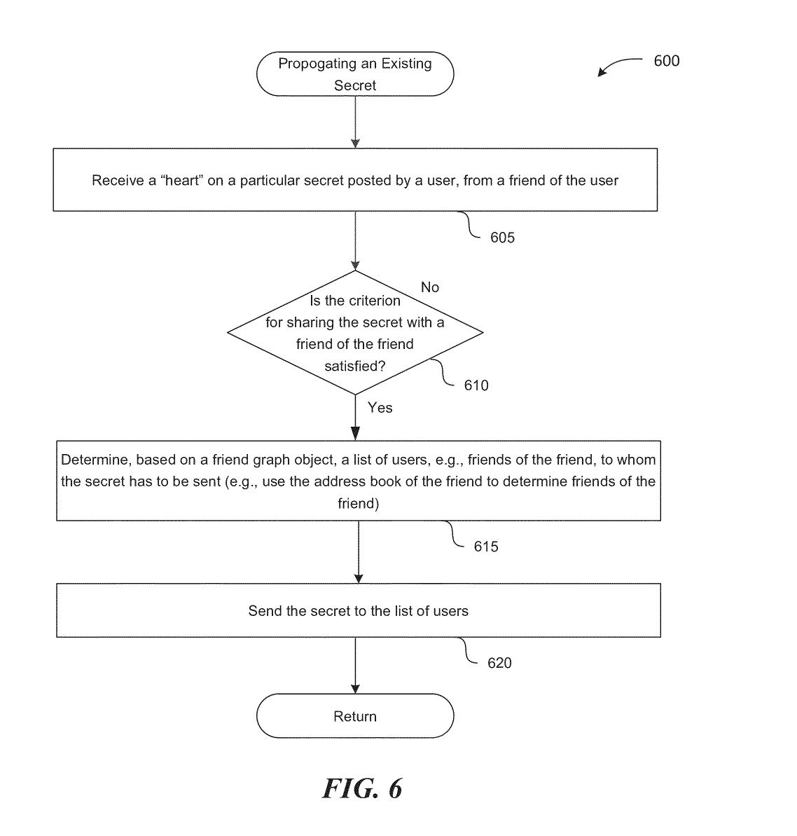

FIG. 6 is a flow diagram of a process for propagating an existing secret to users, in the social networking application 150. The process 600 may be executed in the environment 100. At step 605, a secret of an author receives a “heart” from a friend of the author. At step 610, the server 120 determines whether a criterion for sharing the secret with FoF of the author is satisfied. In some embodiments, the criterion for sharing the secret with a FoF is satisfied when the secret receives a predetermined number of hearts. Responsive to a determination that the criterion for sharing the secret with a FoF is satisfied, at step 615, the server 120 determines the FoF of the author, e.g., using the a friend graph object of the friend of the author, as described at least with reference to FIGS. 1, 3A and 3B.

At step 620, the server 120 may then send the secret to some or all of the FoFs. In some embodiments, as is the case with friends, the server 120 determines the FoFs to whom the secret has to be transmitted based on various propagation factors. Consequently, the secret may continue to be propagated to various degrees of connections of the author as a particular user hearts or loves the secret. In some embodiments, if the secret a particular user is viewing is posted by a user who is beyond 2 degrees of connection to the particular user, that is, beyond a FoF (e.g., FoFoF) of the particular user, the identification tag displays a location, e.g., a state, a city or a geographical distance of the user who posted the secret.

Though the process 600 describes the criterion for determining whether to share the secret with the FoFs is based on a number of hearts the secret receives, the criterion can be based on various other factors, e.g., an amount of time that has elapsed since the secret was posted to the social networking application 150, etc.

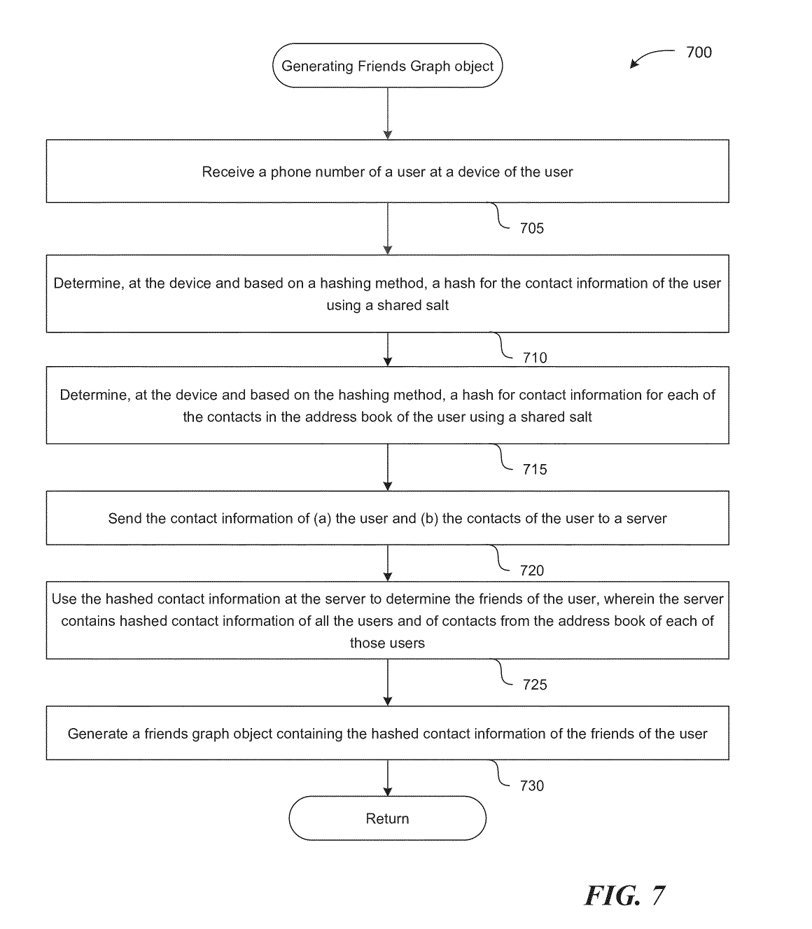

FIG. 7 is a flow diagram of a process 700 for generating a friends graph object having a list of friends of a user. The process 700 may be executed in an environment 100. At step 705, the social networking application 150, e.g., the client portion of the social networking application 150 executing on a user device, receives contact information of the contacts of the user. In some embodiment, the contacts can be a list of individuals in an address book of the user on the user device.

At step 710, the client portion hashes the contact information of the user. The hashing may be performed using a shared salt (that is shared with the server 120). When the contact information is hashed with the salt, a phone number such as [+15552786005] can become hashed data such as [a22d75c92a630725f4].

At step 715, the client portion similarly hashes the contact information of the contacts of the user.

At step 720, the client portion transmits the hashed contact information of the user and the contacts of the user to the server 120. The original phone number and/or email of the contacts may not be uploaded to server 120. While only hashed data of the contact information of the contacts is uploaded to the server 120, the contact information of the user who signed up may be uploaded in both hashed and non-hashed format.

At step 725, after the server 120 receives the contact information of the user and the contacts of the user, the server 120 determines if any of the contacts of the user are also registered with/members of the social networking application 150. The server 120 compares the hashed data of the contact information of each of the contacts of the user with hashed contact information of all other users in the social networking application 150 to determine if there is any match. If there is a match between the hashed contact information of a particular contact of the user and the hashed information of a particular user in the social networking application 150, the server 120 determines that the user is “a friend of” or “a follower of” the particular contact.

At step 730, after identifying all the friends of the user, the server 120 generates a friend graph object containing the hashed data of the contact information of the friends. The server 120 generates a friend graph object for each of the users in the social networking application 150.

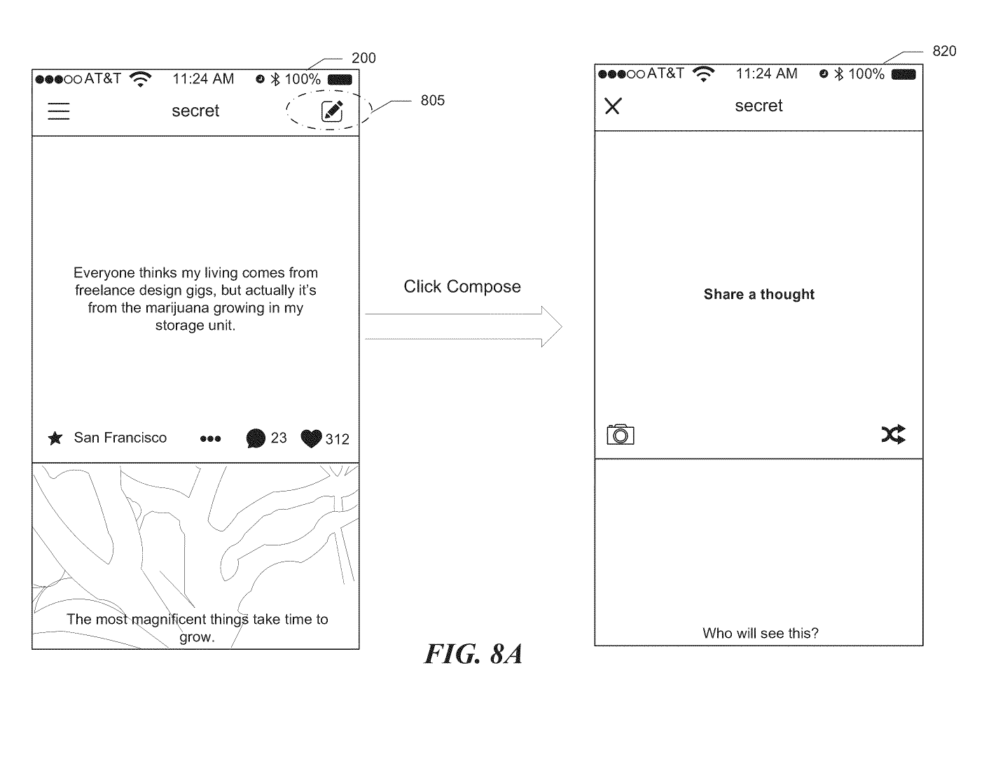

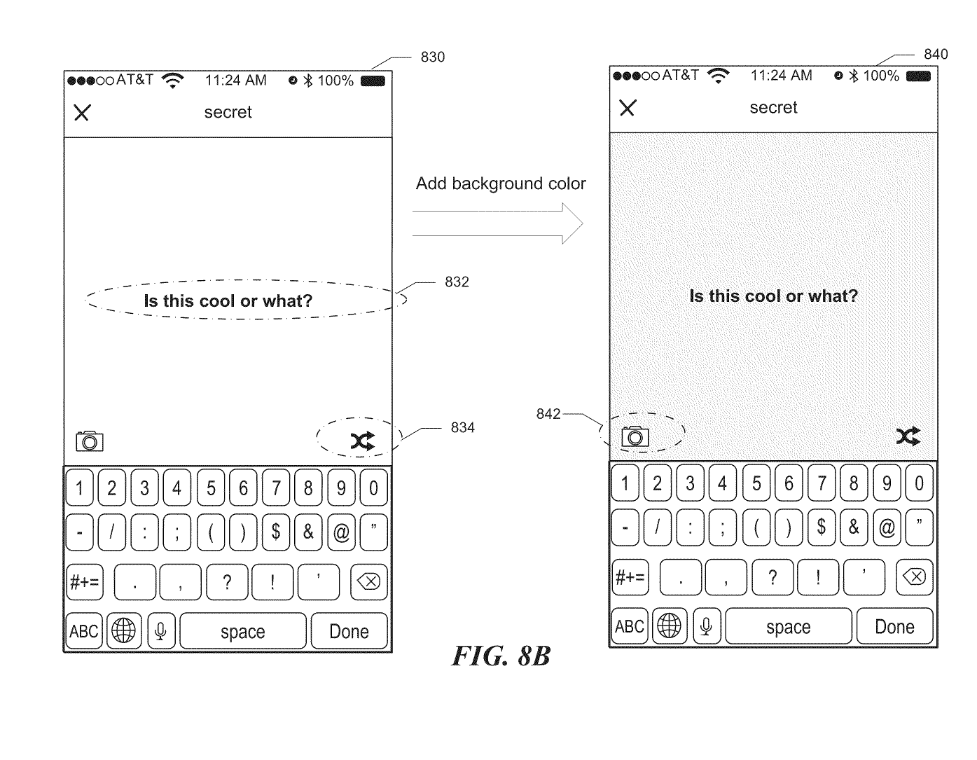

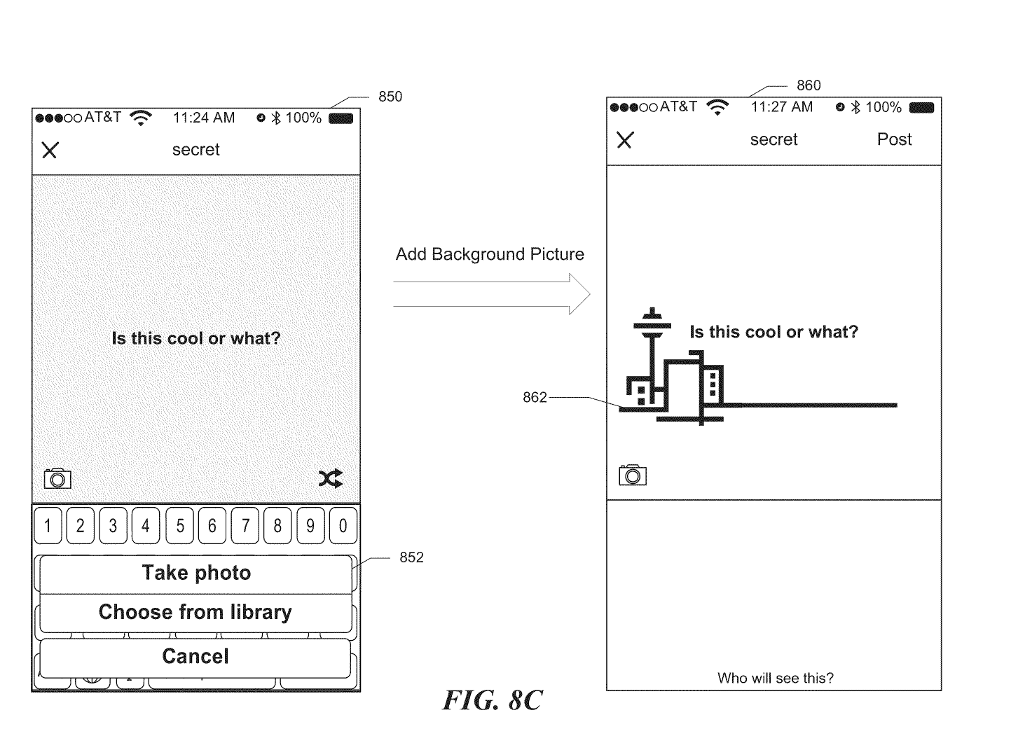

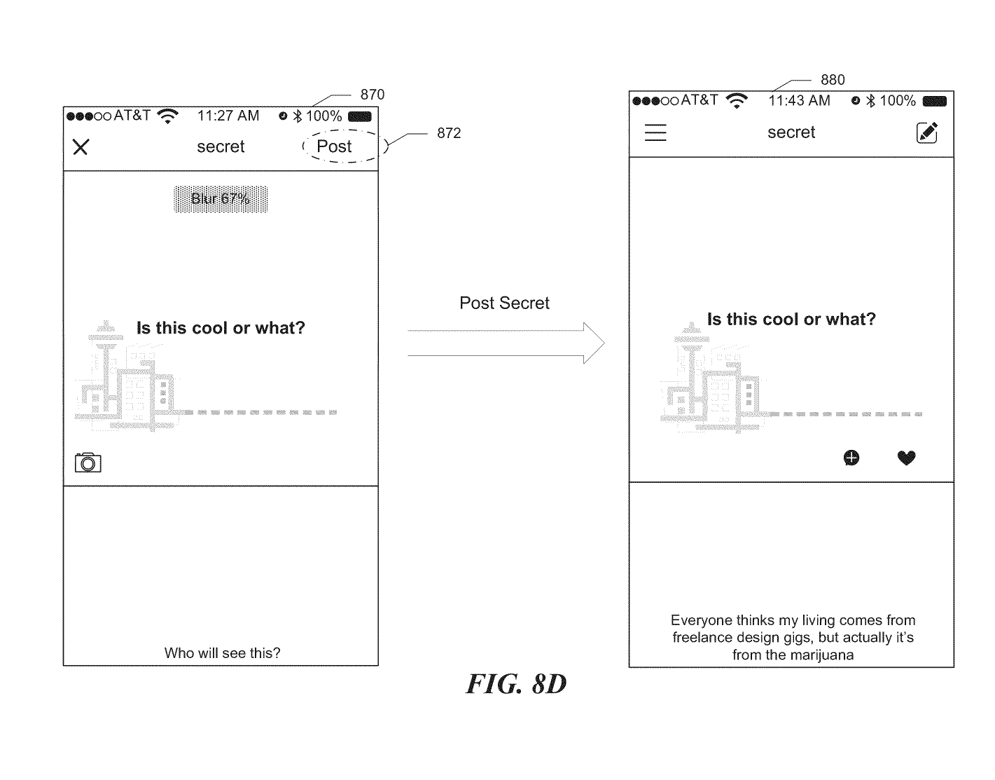

FIG. 8, which includes FIGS. 8A-8D, is an example of GUIs for posting a secret to a social networking application 150 of FIG. 1. FIG. 8A illustrates a news feed of a first GUI 200 of the social networking application 150 where secrets posted by the users are displayed. The GUIs of FIG. 8 can be displayed on a user device such as the user devices 110a-d. Users can comment and/or “heart” the secret using the comment and/or heart GUI elements associated with the secret. A user can compose a message for a new secret from the first GUI 200. For example, the user can select compose GUI element 805 in the first GUI 200 to compose a message of a secret. On selecting the compose GUI element 805, the client portion of the social networking application 150, e.g., a mobile app executing on the user device, displays the second GUI 820 for composing the message of the secret.

The user can compose the message of the secret by inputting the text of the secret 832 as shown in third GUI 830 of FIG. 8B. The user can also add a color background to the message of the secret. For example, the user can select the color background GUI element 834 to add color to the background as shown in fourth GUI 840. In some embodiments, selecting the color background GUI element 834 switches the colors in the background in a random order. The color background can be changed using various user interactions. For example, the color background can be changed by finger swipe gestures (e.g., swipe from left/right of the screen to right/left of the screen). A texture of the color background can be changed by another type of finger swipe gestures. For example, by swiping from top/bottom of the screen to bottom/top of the screen.

FIG. 8C illustrates inputting an image to be displayed as a background to the secret. The user can include an image in the message of the secret to be displayed as a background of the secret 832. For example, the user can select the image background GUI element 842 to add an image to the secret. The mobile application displays the fifth GUI 850 on selection of the image background GUI element 842. The user may use the image selection tool 852 to explore images at the user device and select one of them to be added to message of the secret. The sixth GUI 860 shows an image 862 added to the background of the secret.

FIG. 8D illustrates editing an image background of the secret. The image 862 added to the background of the secret can be edited in various ways, e.g., blurred or dimmed. The editing operations can be performed using various user interactions. For example, the image can be blurred by finger swipe gestures (e.g., swipe from left/right of the screen to right/left of the screen), as illustrated in seventh GUI 870. In some embodiments, the image can be dimmed or brightened by finger swipe gestures (e.g., swipe from top/bottom of the screen to bottom/top of the screen).

When the user is ready to post the message of the secret, the user may do so by selecting a posting GUI element such as the posting GUI element 872 in seventh GUI 870. After the user posts the message of the secret, the server 120 anonymizes the message and transmits the secret to the user. The user can then view the secret in the news feed of the mobile application, e.g., as illustrated in an eighth GUI 880. While the secret is presented on the news feed of the user substantially instantaneously, the social networking application 150 may transmit the secret to the friends of the user at a later time, e.g., based on the delivery mechanism described above.

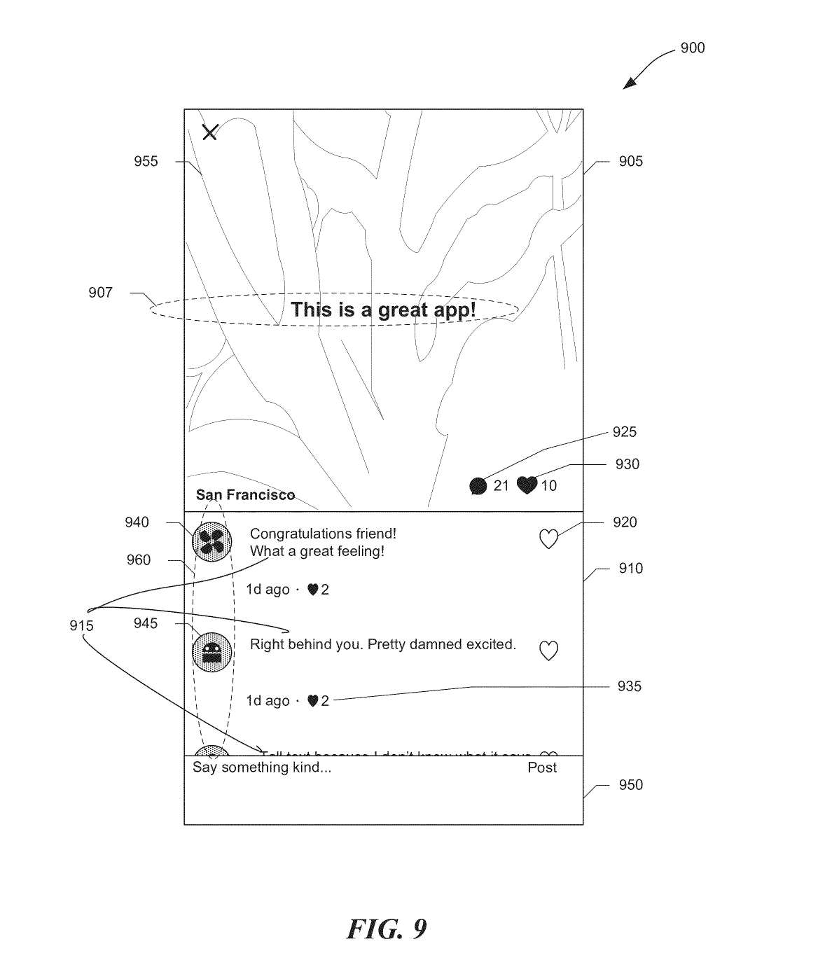

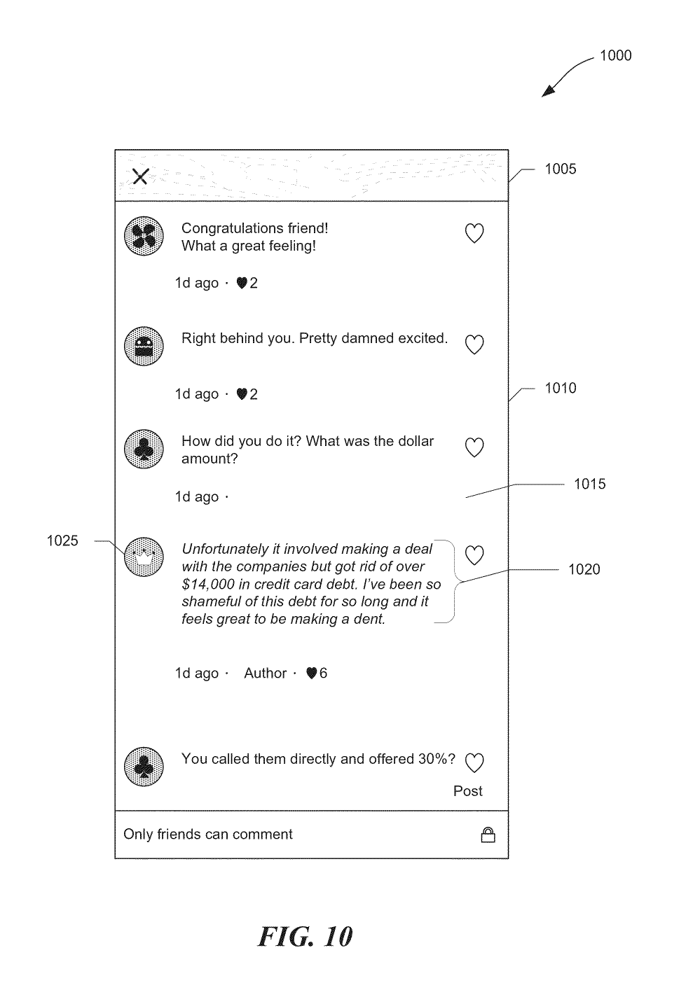

FIGS. 9 and 10 are example GUIs for displaying comments posted on a secret in a social networking application 150 of FIG. 1. FIG. 9 is an example of ninth GUI 900 for displaying a secret 907 and the comments 915 posted on the secret 907. FIG. 10 is an example tenth GUI 1000 for displaying the comments 1015 posted on the secret 907 of FIG. 9. Users can comment on a secret, e.g., using a comment GUI element 925. The comment can include text. The comment is displayed with an icon or an avatar assigned/associated with the user who posted the comment. In some embodiments, an avatar is a graphical representation of the user or the user's alter ego or character. The avatar may take either a three-dimensional form, as in games or virtual worlds, or a two-dimensional form as an icon in Internet forums and other online communities. The avatar can be an object representing the user. The term “avatar” can also refer to the personality connected with the screen name, or handle, of the user. However, the avatars displayed in association with the comments do not reveal the user identification information of the users who posted the comments.

The ninth GUI 900 illustrates comments 915 displayed with their associated avatars 960. Note that the avatars 960 do not reveal any user identification of the users. Each user who comments on a particular secret is assigned a unique avatar from a list of avatars available at the server 120 based on an avatar selection policy. That is, each user is assigned an avatar from the list of available avatars that is not already assigned to any of other users who have commented on the particular secret. However, in some embodiments, the avatars are unique to the users for the comments on the particular secret. That is, an avatar assigned to a user for posting comments on a first secret can be different from an avatar assigned to the user for posting comments on a second secret.

In some embodiments, the avatar selection policy assigns a unique avatar to the user by randomly selecting an avatar from the list of avatars. For example, when a user comments on the particular secret for the first time, the social networking application 150 randomly selects an avatar from the list of avatars that is not already assigned to any of the users who have commented on the particular secret and assigns the randomly selected avatar to the user.

In some embodiments, the avatar selection policy is configured to assign a unique avatar to the user by selecting the avatar from the list of avatars based on contents of the comment made by particular user. For example, when a user comments on the particular secret for the first time, the social networking application 150 analyses the comment to determine a particular category the comment can be classified into. The categories can be based on a theme, an occasion, etc. For example, if the comment is about “romance,” the social networking application 150 can assign an avatar, e.g., a graphical representation of two “hearts,” that relates to the theme “romance.” In another example, if the comment is about cars, the social networking application 150 can assign an avatar, e.g., a graphical representation of a car, that relates to the theme “cars.” The social networking application 150 can various avatars for a particular category.

In some embodiments, the avatar selection policy is configured to assign a unique avatar to the users by selecting the avatars from the list of avatars based on contents of a secret on which the users are commenting. The social networking application 150 analyses the secret to determine a particular category the secret can be classified into. The categories can be based on a theme, an occasion, etc. For example, if the secret is about “food,” the social networking application 150 can assign avatars that relate to the theme “food,” e.g., a graphical representation of various types of food, to the users who comment on the secret. In another example, if the secret is about “fitness,” the social networking application 150 can assign avatars that relate to the theme “fitness,” e.g., a graphical representation of various activities or things associated with “fitness,” to the users commenting on the secret.

Once a user is assigned a unique avatar for commenting on a particular secret, subsequent comments from the user for the particular secret may have the same avatar.

In the ninth GUI 900, the comment “Congratulations, friend! . . . ” on the secret 907 is made by a first user and the comment “Right behind you . . . ” is made by a second user. Accordingly, each of these two users is assigned a unique avatar. For example, the first user is assigned a first avatar 940 and the second user is assigned a second avatar 945. The comments from the first and the second user are associated with their avatars and then displayed with the associated avatars. In the tenth GUI 1000, the comments “How did you do it? . . . ” and “You called them directly . . . ” on the secret 907 are made by the same user and therefore, are displayed with the same avatar, e.g., assigned to the user who posted those comments.

An author of a secret is assigned a predetermined avatar that clearly indicates that a particular comment on the secret is from the author of the secret. In some embodiments, the avatar assigned to an author of any of the secrets is the same. That is, the avatar of a first author of a first secret is same as the avatar of a second author of a second secret. Further, the comment from an author can be visually distinct from that of other users. For example, a format such as a font, color, size, style, of the text of the comment of the author of a secret is different from that of the comments posted by other users. In the tenth GUI 1000, the author of the secret is assigned a “crown” avatar 1025. Accordingly, the comment 1020 from the author is displayed with the “crown” avatar 1025. Further, the text of the comment 1020 is italicized while the text of the comments from the other users are not. In some embodiments, the text is of a different color, e.g., blue, while the text of the comments from other users is in black.

In some embodiments, the list of avatars made available at the server 120 can be changed based on a specific time period. For example, Christmas-themed avatars may be made available during Christmas and the users may be assigned avatars from the Christmas-themed avatars.

Referring back to FIGS. 9 and 10, the ninth GUI 900 displays a secret 907 in a first portion 905 of the ninth GUI 900 and the comments 915 posted on the secret 907 in a second portion 910 of the ninth GUI 900. The first portion 905 has an image as a background to the secret 907. However, in other embodiments, the first portion 905 can have a colored backdrop as a background to the secret 907. The GUI may be rendered on a user device, e.g., a smartphone, associated with a user of the social networking application 150. In some embodiments, if the secret 907 has more comments than those displayed in the comments 915, the user may view those additional comments by maximizing the second portion 910 of the ninth GUI 900 to obtain the tenth GUI 1000 of FIG. 10, which shows more number of comments in comments 1015.

The ninth GUI 900 includes various GUI elements. For example, the first portion 905 of the ninth GUI 900 includes a comment GUI element 925 that indicates a number of comments received on the secret 907. In some embodiments, a comment GUI element can also be used to post a comment on a secret. For example, a comment GUI element such as the comment GUI element 215 of FIG. 2 can be used to post a comment on the first secret 205. On receiving a user selection of the comment GUI element 215, a GUI for posting a comment such as the ninth GUI 900 can be displayed. The user may then input the comment in a portion of the GUI such as third portion 950 of the ninth GUI 900.

The first portion 905 also includes a “heart” GUI element 930. The “heart” GUI element 930 indicates a number of hearts received on the secret 907, which indicates a number of users who “like” the secret 907. The “heart” GUI element 930 also facilitates a user to “like” the secret 907. In some embodiments, when the user “likes” the secret 907 on his/her user device, the “heart” GUI element 930 can change in appearance. For example, when the “heart” GUI element 930 receives a “like,” the color of the “heart” GUI element 930 may change from a first color to a second color, e.g., red, after receiving the “like.” Various such visual appearance changes can be performed on the “heart” GUI element 930 to indicate to the user that the user has “liked” the secret 907.

Each of the comments 915 in the second portion 910 of the ninth GUI 900 includes a comment “heart” GUI element such as comment “heart” GUI element 920. The comment “heart” GUI element 920 facilitates the user to “like” the comment with which the comment “heart” GUI element 920 is associated. A comment can also include a “number of hearts” GUI element 935 that indicates a number of users who have “liked” the comment.

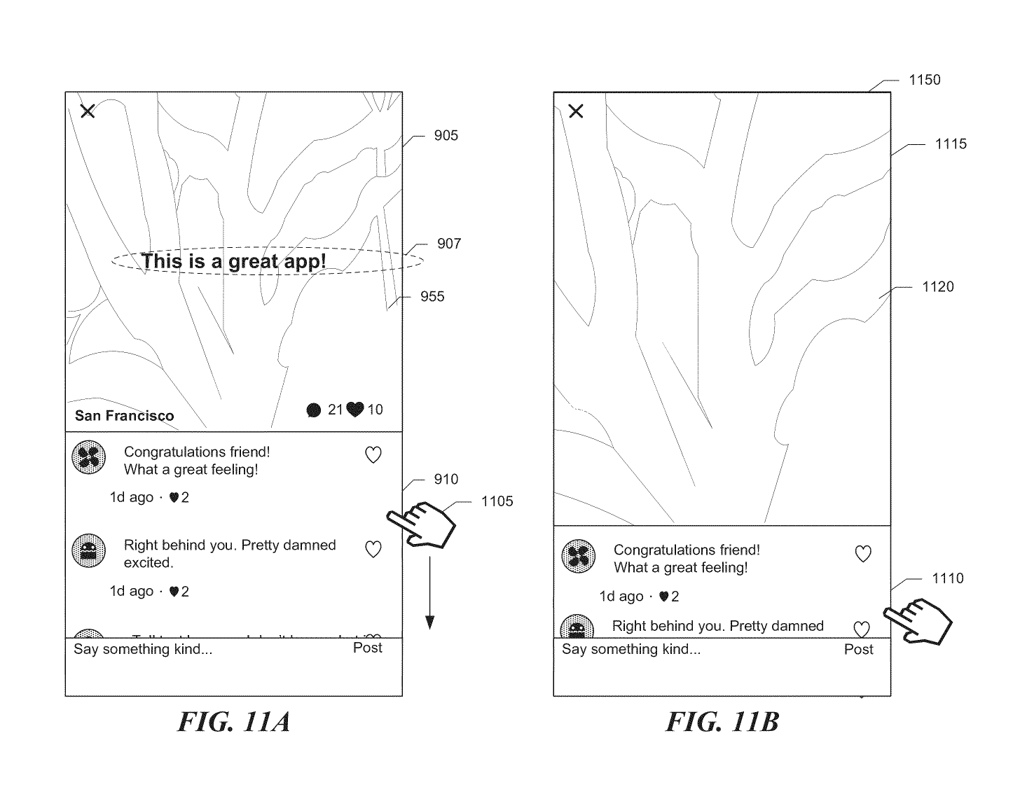

A number of user interactions can be performed on the ninth GUI 900. FIGS. 11A and 11B illustrate an example of a user interaction that can be performed on the ninth GUI 900. A user can perform a user interaction 1105 such as dragging the second portion 910 away from the first portion 905. For example, on a user device such as a smartphone, the user may drag the second portion 910 away from the first portion 905 using a swipe gesture. In some embodiments, while the user drags the second portion 910 away from the first portion 905 to result in the second portion 1110, the secret 907 displayed in the first portion 905 can disappear, as shown in the first portion 1115 of FIG. 11B. The user can view the background of the secret, e.g., image 955, without the secret 907 coming in the way of the background. In some embodiments, the other GUI elements, such as comment GUI element 925 and a “heart” GUI element 930, also disappear from the first portion 905.

Further, the dragging down of the second portion 910 can have a “rubber band” effect on the ninth GUI 900. That is, as the user drags the second portion 910 away from the first portion 905, the first portion 905 expands in size, e.g., occupies a larger real estate of the display of the user device, as shown by first portion 1115 of FIG. 11B. Also, a portion of the contents in the first portion 905 expands. For example, if the first portion 905 has an image 955 in the background, the image 955 expands, e.g., stretches outwards, to result in image 1120, as shown in first portion 1115 of FIG. 11B.

While the first portion 905 expands in size as the user drags the second portion 910 away from the first portion 905, the second portion 910 decreases in size, as shown by the second portion 1110 of FIG. 11B. When the user releases the second portion 1110, both the first portion 1115 and the second portion 1110 return to their original state, as shown by the first and second portions 905 and 910 respectively, of FIG. 11A, respectively.

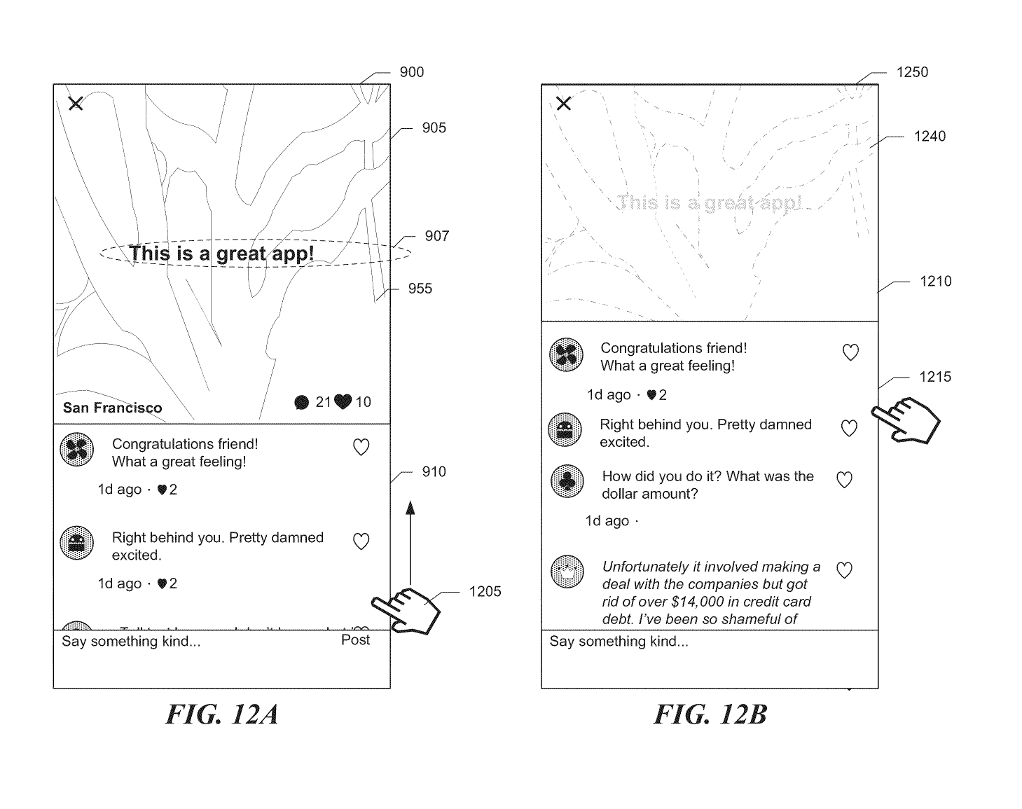

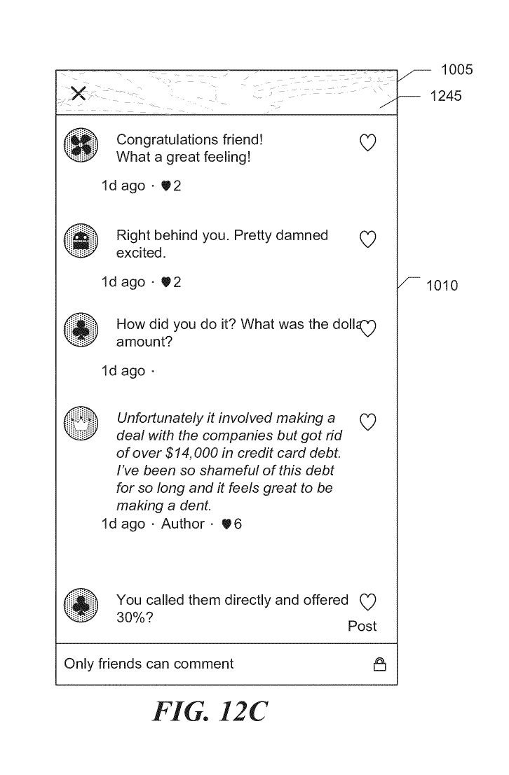

FIGS. 12A, 12B and 12C illustrate an example of a user interaction that can be performed on the ninth GUI 900. A user can perform a user interaction 1205 such as pushing the second portion 910 towards the first portion 905, e.g., to view more comments, as shown by the second portion 1010 in FIG. 12C. For example, on a user device such as a smartphone, the user may push the second portion 910 towards the first portion 905 using a swipe gesture. As the user pushes the second portion 910 towards the first portion 905, the first portion 905 continuously shrinks in area to first portion 1210 of the eleventh GUI 1250 and then collapses to form a strip-like first portion 1005, as shown in FIG. 12C. Simultaneously, the second portion 910 increases in area to form the second portion 1215 as shown in the eleventh GUI 1250 and then the second portion 1010 as shown in FIG. 12C while revealing an increasing number of comments.

Also, while the first portion 905 shrinks to the first portion 1005, the visual characteristics of the contents in the first portion 905 are progressively changed. For example, the image 955 and the secret 907 are progressively blurred, as shown by first content 1240 and second content 1245 in the eleventh GUI 1250 and the tenth GUI 1000, respectively.

In some embodiments, the comments 915 and the comments 1015 include a portion of the comments posted on the secret 907. The user may scroll the comments 1015 in the second portion 1010 to view any additional comments that are not initially displayed. In some embodiments, the comments 1015 displayed in the tenth GUI 1000 can include the comments 915 displayed in the ninth GUI 900. However, a number of the comments 1015 displayed in the tenth GUI 1000 can be more than that of the comments 915 displayed in the ninth GUI 900.

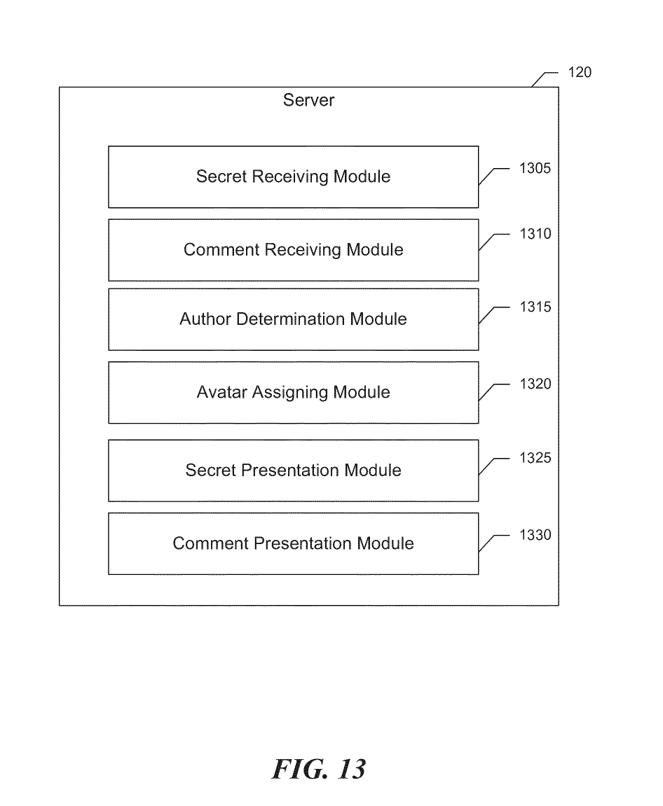

FIG. 13 is a block diagram of the server 120 for facilitating displaying comments associated with a secret at a computing device of a user. In some embodiments, at least a portion of the social networking application 150 can be realized/implemented using various modules of the server 120 depicted in FIG. 13. In some embodiments, the server 120 communicates with a portion of the social networking application 150 executing on the computing device, e.g., as a mobile application, to receive and/or present a secret and comments on the secret. The server 120 includes a secret receiving module 1305 to receive a message of a secret posted by the user. In some embodiments, the user posts the message of the secret to the social networking application 150 via the mobile application. The secret receiving module 1305 can receive the secret from the mobile application. The server 120 includes a comment receiving module 1310 that receives comments posted on the secret from a number of users of the social networking application 150. In some embodiments, the users can post the comments on a secret via the social networking app. The comment receiving module 1310 can receive the comments from the social networking app executing on the computing devices associated with the users.

The server 120 includes an author determination module 1315 to determine if any of the comments are posted by an author of the secret. In some embodiments, the author determination module 1315 uses user information, such as email ID and/or phone number or a hashed version of the email ID and/or phone number of the user to determine if the comment is posted by an author of the secret. For example, the author determination module 1315 compares user information of the user who posted the comment with that of the author of the secret to determine if the comment is posted by the author. If the comment is posted by the author, the avatar assigning module 1320 assigns a predetermined avatar to the author and associates the comment posted by the author with the predetermined avatar. The predetermined avatar clearly indicates that a particular comment on the secret is from the author of the secret. In some embodiments, the avatar assigned to an author of any of the secrets is the same. Further, a user such as an administrator of the social networking application 150 can configure a particular avatar from the list of avatars available at the server 120, e.g., in the storage medium 125, as the avatar for an author of a secret.

The avatar assigning module 1320 assigns a unique avatar to each user who comments on a particular secret. That is, each user is assigned an avatar from the list of available avatars that is not already assigned to any of the users who have commented on the particular secret. However, in some embodiments, the avatars are unique to the users for the comments on the particular secret. That is, an avatar assigned to a user for posting comments on a first secret can be different from an avatar assigned to the user for posting comments on a second secret.

The avatars can be assigned based on an avatar selection policy. In some embodiments, the avatar selection policy is configured to assign a unique avatar to the user by selecting the avatar from the list of avatars in a random manner. For example, when a user comments on the particular secret for the first time, the social networking application 150 randomly selects an avatar from the list of avatars that is not already assigned to any of the users who have commented on the particular secret and assigns the randomly selected avatar to the user. The avatar assigning module 1320 associates each of the comments with an avatar assigned to the user who posted the corresponding comment.

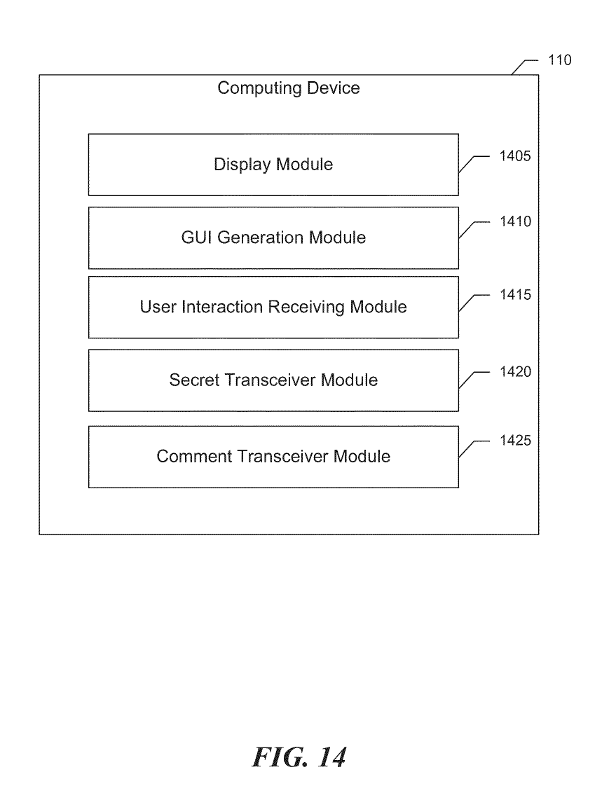

The secret presentation module 1325 anonymizes the message posted by the user to generate the secret and sends the secret to the computing devices of the users for further display. In some embodiments, the secret presentation module 1325 implements the delivery mechanism of the social networking application 150. As discussed above, at least with reference to FIG. 1, the delivery mechanism determines the list of users, e.g., friends of a user, to whom a particular secret posted by a particular user has to be transmitted to. The comment presentation module 1330 sends the comments on the secret to the computing devices of the users. In some embodiments, the secret and the comments on the secret are displayed via the social networking app executing on the computing device. Additional details with respect to the server 120 are described in the following paragraphs, at least with reference to FIGS. 14-18.

FIG. 14 is a block diagram of a computing device 110 for generating a GUI to share a secret and comments on the secret with users of a social networking application 150. The computing device 110 can represent any of the computing devices 110a-d of FIG. 1. In some embodiments, the computing device 110 is similar to the computing device 110a and is associated with user 105a. In some embodiments, at least a portion of the social networking application 150, e.g., client portion or social networking apps, can be realized/implemented using various modules of the computing device 110.

The computing device 110 includes a GUI generation module 1410 that generates the GUI for sharing a secret and comments on the secret between the users 105a-d. In some embodiments, the GUI generation module 1410 generates a GUI for displaying a plurality of secrets. For example, the GUI generation module 1410 generates the first GUI 200 for displaying a plurality of secrets, including secrets 205 and 210. In some embodiments, the GUI generation module 1410 generates a GUI for displaying a secret and comments on the secret. For example, the GUI generation module 1410 generates the ninth GUI 900 for displaying a secret 907 and the comments, including comments 915, associated with the secret 907. In some embodiments, the secret is displayed in a first portion of the GUI and the comments on the secret in a second portion of the GUI. For example, the GUI generation module 1410 generates the ninth GUI 900 for displaying the secret in the first portion 905 of the ninth GUI 900 and the comments 915 of the secret 907 on the second portion 910.

The GUI generation module 1410 can also generate a GUI for the user 105a to post a comment on the secret. For example, the user 105a can comment on the secret 907 by inputting the comment in the third portion 950 of the ninth GUI 900. The computing device 110 includes a secret transceiver module 1420 to receive a secret input by the user 105a at the computing device 110. The secret transceiver module 1420 can also transmit the secret input by the user 105a to the server 120 for further transmission to other users of the social networking application 150, e.g., users 105b-d. The computing device 110 includes a comment transceiver module 1425 to receive comments from a user 105a for one or more secrets posted to the social networking application 150. The comment transceiver module 1425 can also transmit the comments input by the user 105a to the server 120 for further transmission to other users of the social networking application 150, e.g., users 105b-d.

The computing device 110 also includes a user interaction module 1415 that receives user selections or user interactions from the user 105a. The user interactions can result in a change to the GUI generated by the GUI generation module 1410, which can cause the GUI generation module 1410 to regenerate the GUI. For example, as described in association with FIGS. 11A-11B and 12A-12C, the user can perform operations such as drag or push a second portion 910 of the ninth GUI 900 away or towards the first portion 905 which results in regenerating the ninth GUI 900.

The computing device 110 includes a display module 1405 to display the GUI generated by the GUI generation module 1410 to the user 105a.

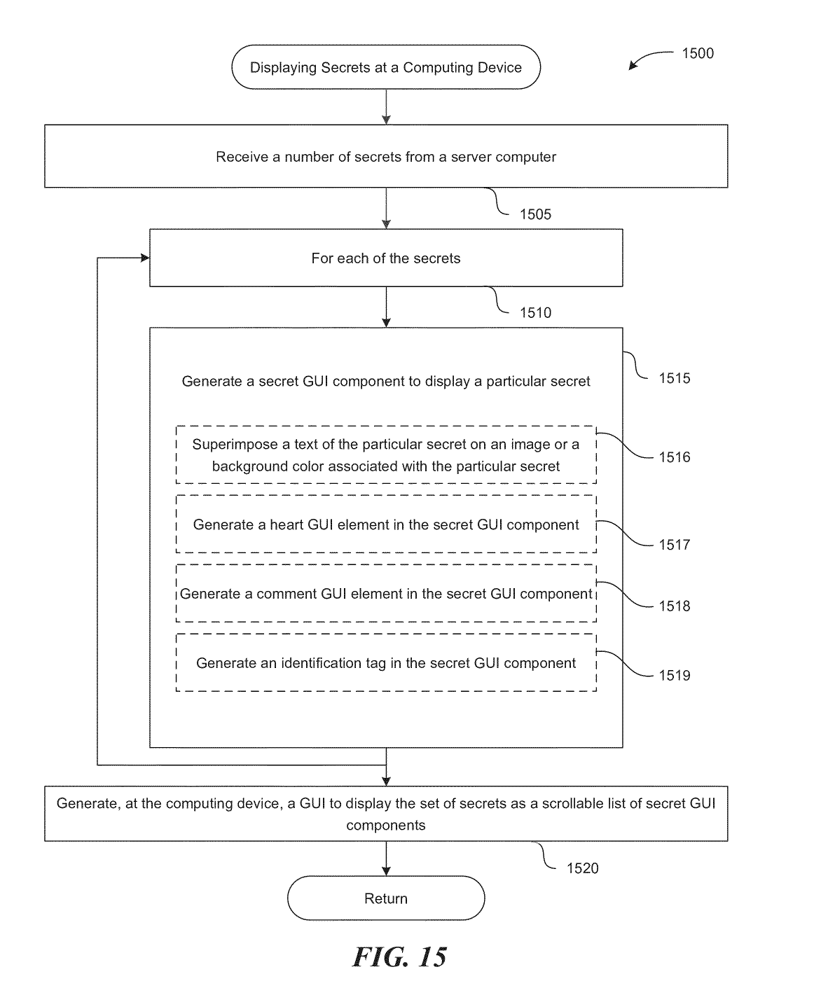

FIG. 15 is a flow diagram of a process for generating a GUI at a computing device for displaying secrets posted in a social networking application. In some embodiments, the process 1500 may be executed in the environment 100 of FIG. 1 and using the server 120 and the computing device 110. At step 1505, the secret transceiver module 1420 receives a number of secrets from the server 120. In some embodiments, each of the secrets includes a text and one of an image or a background color. The text and the image or the background color are input the authors of the corresponding secret.

At step 1510, the GUI generation module 1410 performs the step 1515 of generating secret GUI components for each of the secrets received at the computing device 110. At step 1515, the GUI generation module 1410 generates a secret GUI component for displaying a particular secret. For example, the GUI generation module 1410 generates the first secret GUI component 207 for displaying the first secret 205. The secret GUI component can be of a particular shape and dimension. In some embodiments, the GUI generation module 1410 performs the steps 1516-1519 to generate the secret GUI component.

At step 1516, the GUI generation module 1410 superimposes the text of the particular secret and an image or a background color associated with the particular secret in the secret GUI module. For example, the secret GUI component displays the text as a foreground of the secret GUI component and the one of the image or the background color as a background of the secret GUI component.

At step 1517, the GUI generation module 1410 generates a heart GUI element, e.g., heart GUI element 220, in the secret GUI component. The heart GUI element can indicate a number of “likes” received for the particular secret which indicates a number of the users who liked the particular secret. The heart GUI element can also facilitate the user to “like” the particular secret.

At step 1518, the GUI generation module 1410 generates a comment GUI element, e.g., comment GUI element 215, in the secret GUI component. The comment GUI element can indicate a number of comments received for the particular secret. The comment GUI element can also facilitate the user to comment on the particular secret.

At step 1519, the GUI generation module 1410 generates an identification tag, e.g., identification tag 230, in the secret GUI component. In some embodiments, the identification tag can display a location of the author of the particular secret. In some embodiments, the identification tag can display relationship information, which indicates a relationship between the author of the particular secret and the user of the computing device 110 who is viewing the particular secret.

The GUI generation module 1410 performs the step 1515 for each of the secrets and generates a number of secret GUI components. In some embodiments, the GUI generation module 1410 generates the secret GUI components in a same shape and with same dimensions.

At step 1520, the GUI generation module 1410 generates a GUI having the secret GUI components as a scrollable list and displays the GUI at the computing device 110. For example, the GUI generation module 1410 generates the first GUI 200 having the secret GUI components 207 and 212 as a scrollable list in the news feed 235.

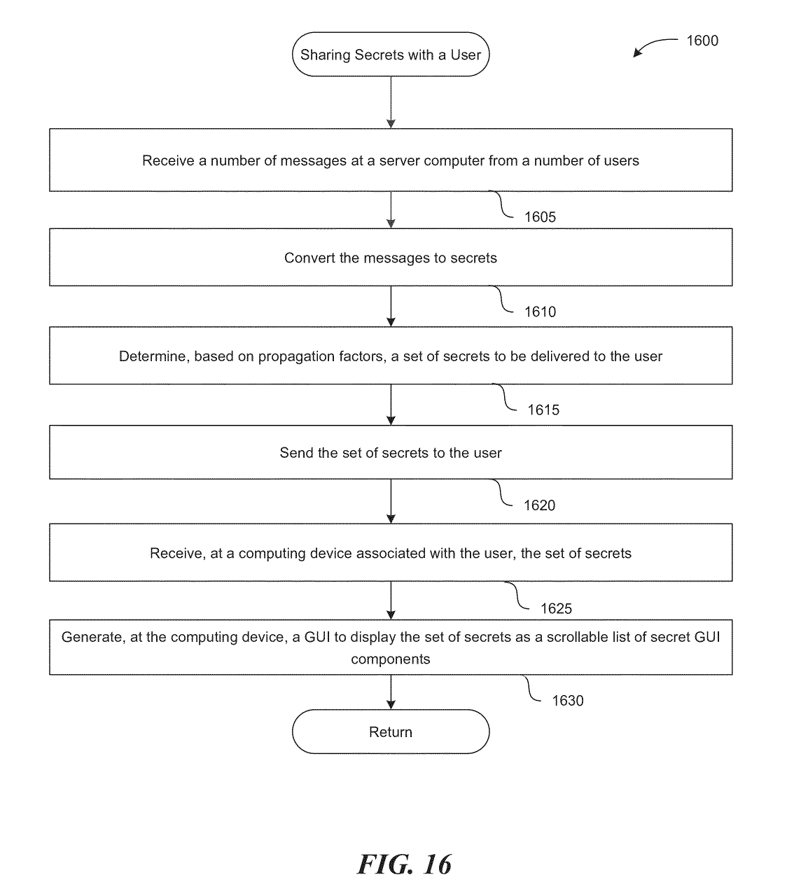

FIG. 16 is a flow diagram of a process 1600 for sharing a set of secrets with a user of the social networking application 150. In some embodiments, the process 1600 may be executed in the environment 100 of FIG. 1 and using the server 120 and the computing device 110. At step 1605, the secret receiving module 1305 of the server 120 receives messages of a number of secrets from a number of users of the social networking application 150. In some embodiments, the users can compose the messages of the secrets using a client portion of the social networking application 150 executing on the computing device associated with the users. For example, the users can compose a message of a secret as illustrated in FIGS. 8A-8D.

At step 1610, the secret receiving module 1305 converts the messages to corresponding secrets. The secret receiving module 1305 converts the messages to corresponding secrets by anonymizing the messages. In some embodiments, if secret receiving module 1305 has not anonymized the messages received from the users, the secret presentation module 1325 anonymizes the messages to generate the corresponding secrets, e.g., before transmitting the set of secrets to the user. The secret presentation module 1325 may determine whether the messages have been anonymized before transmitting them to the users.

At step 1615, the secret presentation module 1325 determines a set of the secrets to be displayed to the user. In some embodiments, the secret presentation module 1325 determines the set of secrets to be displayed to the user as a function of various propagation factors. For example, the set of secrets to be displayed to the user is determined based on a function of the number of friends the user has. If the number of friends the user has is less than a threshold, then the secrets posted by the friends of the user may not displayed to the user.

At step 1620, the secret presentation module 1325 transmits the set of secrets to the user, e.g., to the computing device associated with the user.

At step 1625, the secret transceiver module 1420 of the computing device 110 receives the set of secrets from the server 120. At step 1630, the GUI generation module 1410 displays the set of secrets as a scrollable list of secret GUI components at the display module 1405 of the computing device 110. In some embodiments, the GUI generation module 1410 displays the set of secrets as described at least with reference to process 1500.

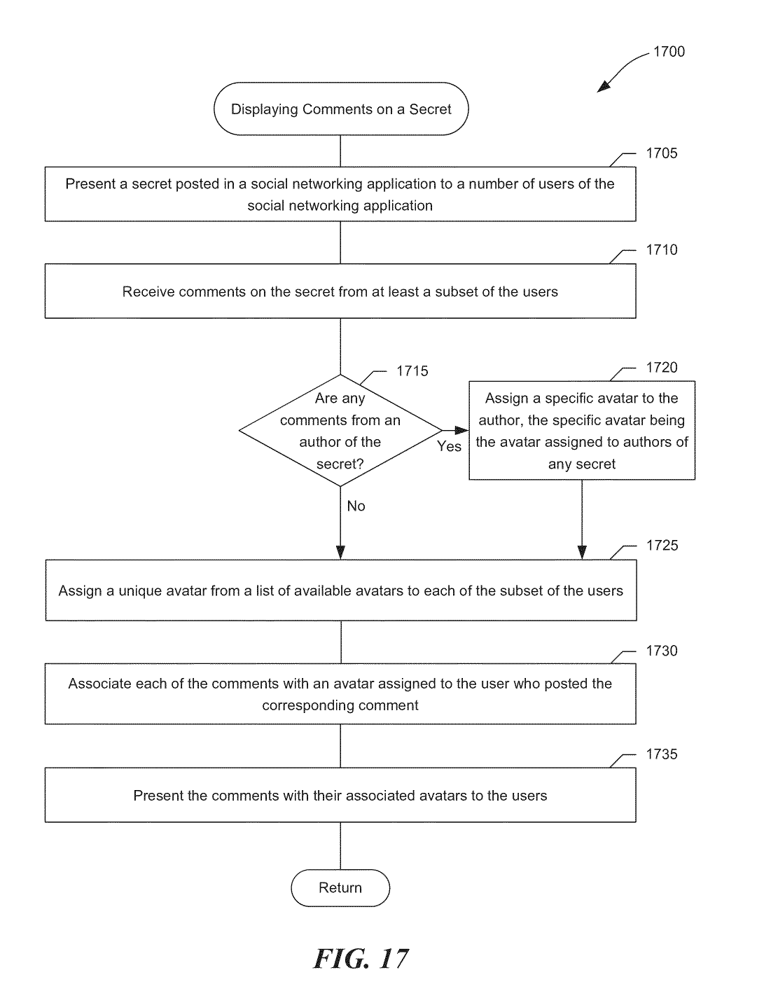

FIG. 17 is a flow diagram of a process for displaying comments posted on a secret in a social networking application. In some embodiments, the process 1700 may be executed in the environment 100 of FIG. 1 and using the server 120. At step 1705, a secret presentation module 1325 presents a secret to a number of users of the social networking application 150. For example, the secret presentation module 1325 can transmit a secret 907 of FIG. 9 of a user 105a to the users 105a-d. The user 105a can post the message of the secret via a mobile application executing on the computing device 110a associated with the user 105a. In some embodiments, the user 105a can post the message of the secret via email, text message or a tweet.

At step 1710, the comment receiving module 1310 receives comments on the secret from a number of users, e.g., at least a subset of the users 105a-d. The users can post comments on the secret via the social networking apps executing on their corresponding computing devices.

At step 1715, the author determination module 1315 determines if any of the comments received on the secret are from the author of the secret. For example, the author determination module 1315 determines if any of the comments received for the secret 907 are posted by the user 105a, who is the author the secret 907. In some embodiments, the author determination module 1315 uses user information, such as email ID and/or phone number or a hashed version of the email ID and/or phone number of the user to determine if the comment is posted by an author of the secret. For example, the author determination module 1315 compares user information of the user who posted the comment with that of user 105a to determine if the comment is posted by the user 105a.

Responsive to a determination that one or more of the comments are posted by the author of the secret, at step 1720, the avatar assigning module 1320 assigns a predetermined avatar to the author and associates the one or more comments posted by the author with the predetermined avatar. The predetermined avatar clearly indicates that a particular comment on the secret is posted by the author of the secret. For example, the avatar assigning module 1320 assigns a crown avatar 1025 of FIG. 10 to the user 105a who is the author of the secret 907 for posting the comment 1020. In some embodiments, the avatar assigned to an author of any of the secrets is the same. After assigning the predetermined avatar to the author, the process 1700 proceeds to the step 1725.

Responsive to a determination that none of the comments are posted by the author of the secret, at step 1725, the avatar assigning module 1320 assigns an unique avatar to each user who has posted one or more comments on the secret. That is, each user is assigned an avatar from the list of available avatars that is not already assigned to any of the users who have commented on the secret. For example, the avatar assigning module 1320 assigns unique avatars 940 and 945 to two users who posted comments on the secret 907. However, in some embodiments, the avatars are unique to the users for the comments posted on a particular secret. That is, an avatar assigned to a user for posting comments on a first secret can be different from an avatar assigned to the user for posting comments on a second secret.

The avatars can be assigned to the users based on an avatar selection policy. In some embodiments, the avatar selection policy is configured to assign a unique avatar to the user by selecting the avatar from the list of avatars in a random manner. For example, when a user, e.g., user 105b, comments on the secret 907 for the first time, the social networking application 150 randomly selects an avatar, e.g., first avatar 940, from the list of avatars that is not already assigned to any of the users who have commented on the secret 907 and assigns the randomly selected avatar first 940 to the user 105b.

At step 1730, the avatar assigning module 1320 associates each of the comments posted on the secret with an avatar assigned to the user who posted the corresponding comment.

At step 1735, the comment presentation module 1330 presents the comments to the users 105a-d for display at their corresponding computing devices. For example, the comment presentation module 1330 can transmit the secret 907 and the comments, including comments 915, to the users 105a-d. When the users 105a-d view the comments in their computing devices 110a-d, the comments are displayed with the associated avatars.

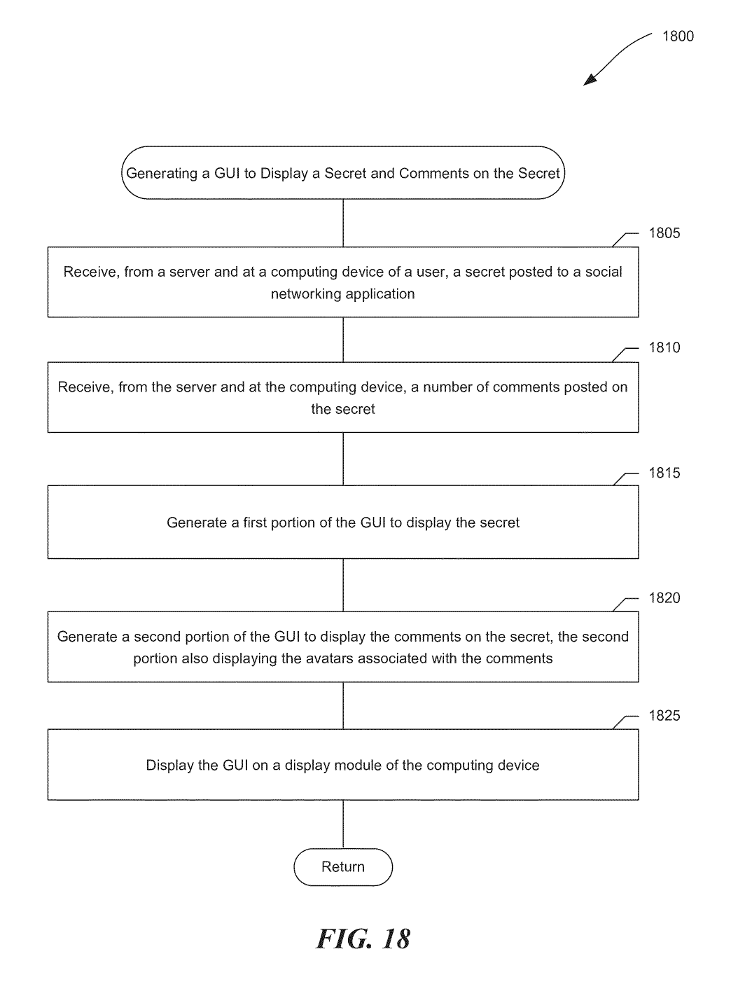

FIG. 18 is a flow diagram of a process for generating a GUI for displaying a secret and comments posted on the secret in a social networking application. In some embodiments, the process 1800 may be executed in the environment 100 of FIG. 1 and using the server 120 and the computing device 110. At step 1805, a secret transceiver module 1420 receives a secret posted by a user in the social networking application 150 from the server 120. For example, the computing device 110b receives the secret 907 posted by the user 105a.

At step 1810, the comment transceiver module 1425 receives the comments posted on the secret from the server 120. For example, the computing device 110b receives the comments, including comments 915, posted on the secret 907.

At step 1815, the GUI generation module 1410, generates a first portion of a GUI for displaying the secret received at step 1805. For example, the computing device 110b generates a first portion 905 of the ninth GUI 900 to display the secret 907.

At step 1820, the GUI generation module 1410, generates a second portion of the GUI for displaying the comments posted on the secret. The second portion of the GUI also displays the avatars associated with each of the comments. For example, the computing device 110b generates a second portion 910 of the ninth GUI 900 to display the comments 915 posted on the secret 907. The comments 915 also include avatars such as avatars 940 and 945.

At step 1825, the display module 1405 displays the GUI, including the first portion and the second portion. For example, the computing device 110b displays the ninth GUI 900 with the secret 907 in the first portion 905 and the comments (at least some) in the second portion 910.

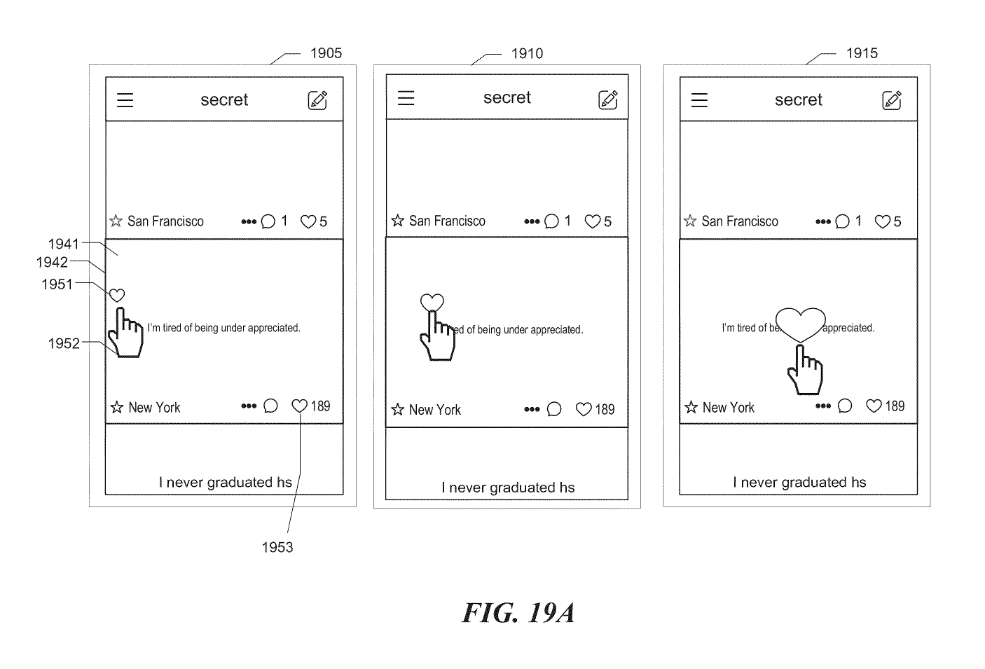

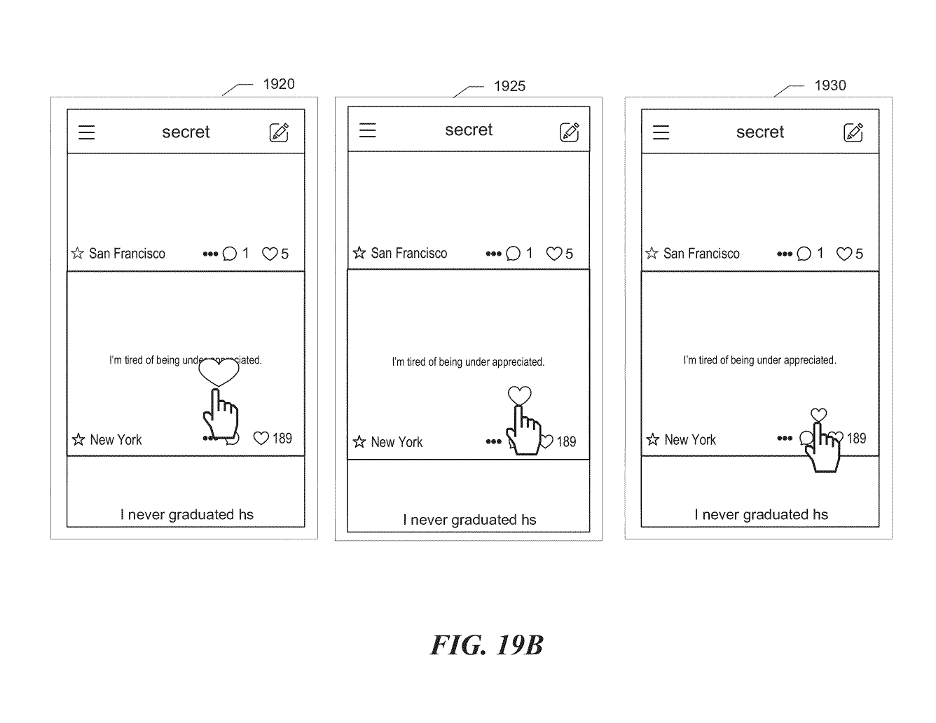

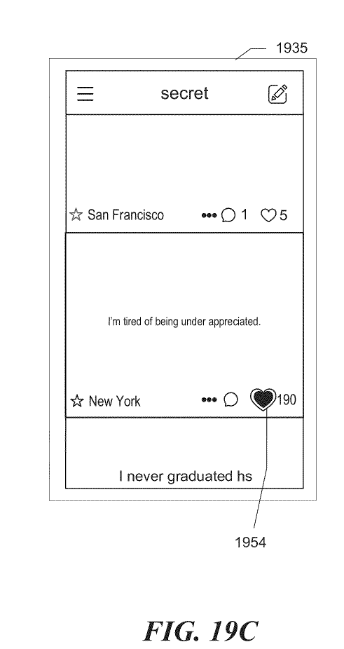

FIGS. 19A-19C are example GUIs illustrating a swipe user interaction for liking a secret. The twelfth GUI 1905 displays a secret 1941 in a secret GUI component 1942. In some embodiments, the twelfth GUI 1905 can be similar to the first GUI 200 of FIG. 2, the secret 1941 can be similar to the first secret 205 and the secret GUI component 1942 to the first secret GUI component 207. A user can like the secret 1941 by performing a swipe action 1952 in the secret GUI component 1942. Note that the image of a hand is shown for illustrating a swipe action from the user and is not part of the GUIs 1905-1935. The user can perform the swipe action 1952 by swiping from a first portion of the secret GUI component 1942, e.g., a left edge of the secret GUI component 1942, towards the heart GUI element 1953. In some embodiments, the twelfth GUI 1905 generates an animation of a graphical image 1951 as a result of the swipe action 1952. The animation causes the graphical image 1951 to move along a path from the first portion of the secret GUI component 1942 to the heart GUI element 1953 as illustrated in GUIs 1905-1935. When the graphical image 1951 merges with the heart GUI element 1953, the secret 1941 receives a like, as illustrated in GUI 1935.

After the secret 1941 receives a like, a count of the number of “likes” received by the secret 1941 increases, as illustrated in GUI 1935. Further, a visual format of the heart GUI element 1953 may change to a different visual format after the secret 1941 receives the like, as illustrated by the heart GUI element 1954 in FIG. 19C. For example, the heart GUI element 1954 may be displayed with a specific fill color such as red.

The swipe action 1952 can be performed in different ways, e.g., the user can swipe from the right edge of the secret GUI component 1942. In some embodiments, the user may not drag the graphical image 1951 all the way to the heart GUI element 1953 for the graphical image 1951 to merge with the heart GUI element 1953. For example, the user can swipe until a given portion, e.g., halfway from the first portion to the heart GUI element 1953 as illustrated in GUI 1915, and the graphical image 1951 continues to move along the path to the heart GUI element 1953.

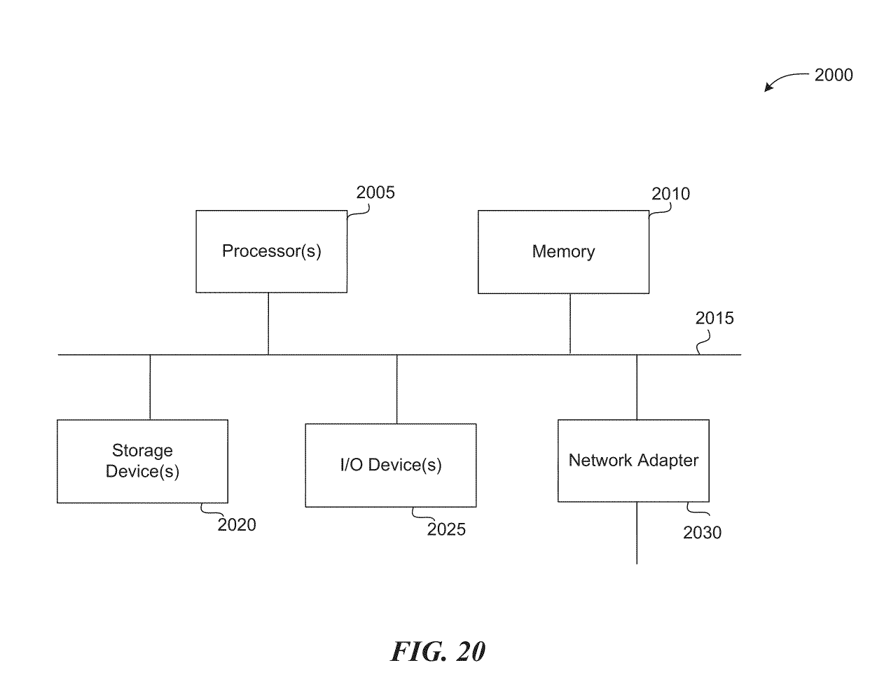

FIG. 20 is a block diagram of a computer system as may be used to implement features of some embodiments of the disclosed technology. The computing system 2000 may be used to implement any of the entities, components or services depicted in the examples of FIGS. 1-19 (and any other components described in this specification). The computing system 2000 may include one or more central processing units (“processors”) 2005, memory 2010, input/output devices 2025 (e.g., keyboard and pointing devices, display devices), storage devices 2020 (e.g., disk drives), and network adapters 2030 (e.g., network interfaces) that are connected to an interconnect 2015. The interconnect 2015 is illustrated as an abstraction that represents any one or more separate physical buses, point to point connections, or both connected by appropriate bridges, adapters, or controllers. The interconnect 2015, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (I2C) bus, or an Institute of Electrical and Electronics Engineers (IEEE) standard 1394 bus, also called “Firewire”.

The memory 2010 and storage devices 2020 are computer-readable storage media that may store instructions that implement at least portions of the described technology. In addition, the data structures and message structures may be stored or transmitted via a data transmission medium, such as a signal on a communications link. Various communications links may be used, such as the Internet, a local area network, a wide area network, or a point-to-point dial-up connection. Thus, computer-readable media can include computer-readable storage media (e.g., “non-transitory” media) and computer-readable transmission media.

The instructions stored in memory 2010 can be implemented as software and/or firmware to program the processor(s) 2005 to carry out actions described above. In some embodiments, such software or firmware may be initially provided to the computing system 2000 by downloading it from a remote system through the computing system 2000 (e.g., via network adapter 2030).

The technology introduced herein can be implemented by, for example, programmable circuitry (e.g., one or more microprocessors) programmed with software and/or firmware, or entirely in special-purpose hardwired (non-programmable) circuitry, or in a combination of such forms. Special-purpose hardwired circuitry may be in the form of, for example, one or more ASICs, PLDs, FPGAs, etc.

### Remarks

The above description and drawings are illustrative and are not to be construed as limiting. Numerous specific details are described to provide a thorough understanding of the disclosure. However, in some instances, well-known details are not described in order to avoid obscuring the description. Further, various modifications may be made without deviating from the scope of the embodiments. Accordingly, the embodiments are not limited except as by the appended claims.

Reference in this specification to “one embodiment” or “an embodiment” means that a particular feature, structure, or characteristic described in connection with the embodiment is included in at least one embodiment of the disclosure. The appearances of such phrases in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

The terms used in this specification generally have their ordinary meanings in the art, within the context of the disclosure, and in the specific context where each term is used. Terms that are used to describe the disclosure are discussed below, or elsewhere in the specification, to provide additional guidance to the practitioner regarding the description of the disclosure. For convenience, some terms may be highlighted, for example using italics and/or quotation marks. The use of highlighting has no influence on the scope and meaning of a term; the scope and meaning of a term is the same, in the same context, whether or not it is highlighted. It will be appreciated that the same thing can be said in more than one way. One will recognize that “memory” is one form of a “storage” and that the terms may on occasion be used interchangeably.

Consequently, alternative language and synonyms may be used for any one or more of the terms discussed herein, nor is any special significance to be placed upon whether or not a term is elaborated or discussed herein. Synonyms for some terms are provided. A recital of one or more synonyms does not exclude the use of other synonyms. The use of examples anywhere in this specification including examples of any term discussed herein is illustrative only, and is not intended to further limit the scope and meaning of the disclosure or of any exemplified term. Likewise, the disclosure is not limited to various embodiments given in this specification.

Those skilled in the art will appreciate that the logic illustrated in each of the flow diagrams discussed above, may be altered in various ways. For example, the order of the logic may be rearranged, substeps may be performed in parallel, illustrated logic may be omitted; other logic may be included, etc.

Without intent to further limit the scope of the disclosure, examples of instruments, apparatus, methods and their related results according to the embodiments of the present disclosure are given below. Note that titles or subtitles may be used in the examples for convenience of a reader, which in no way should limit the scope of the disclosure. Unless otherwise defined, all technical and scientific terms used herein have the same meaning as commonly understood by one of ordinary skill in the art to which this disclosure pertains. In the case of conflict, the present document, including definitions will control.

1. A computer-implemented method for sharing a plurality of messages posted by a plurality of users in a social networking application, the computer-implemented method comprising:
receiving, at a server computer, a first message of the messages from a first user of the users, the first message including multimedia content input by the first user, wherein the first user generates the first message using a portion of the social networking application executing on a computing device associated with the first user;
anonymizing, at the server computer, the first message to generate a first secret, the anonymizing including removing, from the first message, user identification information that determines or is used to determine an identity of the first user;
identifying, by the server computer, a set of users of the social networking application as a plurality of friends of the first user, the identifying including:
comparing a first set of hashed contact information of a plurality of contacts in an address book of the first user with a second set of hashed contact information of the users to determine a match, and
determining, based on the match, some of the users as the set of users; and
sending, by the server computer, the first secret to a subset of the friends based on a first propagation policy, the first propagation policy configured to identify those of the friends with whom an anonymity of the first user is not lost upon sharing the first secret as the subset of the friends.

2. The computer-implemented method of claim 1, wherein sending the first secret to the subset of the friends includes:
for each of the set of users,
computing, by the server computer, a number of friends a specified user has in the social networking application as a first value,
confirming that the first value satisfies the first propagation policy,
determining that the anonymity of the first user is maintained with the specified user, and
adding the specified user to the subset of the friends.

3. The computer-implemented method of claim 2 further comprising:
confirming that the first value does not satisfy the first propagation policy;
determining that the anonymity of the first user is lost upon sharing the first secret with the specified user; and
excluding, by the server computer, the specified user from the subset of the friends.

4. The computer-implemented method of claim 1, wherein the first secret is one of a first set of secrets posted by the first user, the computer-implemented method further comprising:
sending, by the server computer, the first set of secrets to the subset of the friends based on the first propagation policy, the sending including sending the first set of secrets in a different order to different friends.

5. The computer-implemented method of claim 1, wherein the first secret is one of a first set of secrets posted by the first user, the computer-implemented method further comprising:
sending, by the server computer, the first set of secrets to the subset of the friends based on the first propagation policy, the sending including sending the first set of secrets at different time intervals to different friends.

6. The computer-implemented method of claim 1, wherein the first secret is one of a first set of secrets posted by the first user, the computer-implemented method further comprising:
sending, by the server computer, the first set of secrets to the subset of the friends based on the first propagation policy, the sending including sending the first set of secrets in an order different from that of a set of messages corresponding to the first set of secrets is received from the first user.

7. The computer-implemented method of claim 1, wherein sending the first secret to the subset of the friends includes:
for each of the set of users who is included in the subset of the friends, sending a tag with the first secret, the tag including a relationship information of the first user with a specified user.

8. The computer-implemented method of claim 7, wherein the relationship information is of a first type, a second type, or a third type, the first type indicating that the specified user and an author of a secret transmitted to the specified user share a first degree relationship, the second type indicating that the specified user and the author share a second degree relationship, the third type indicating that the specified user and the author share either the first degree relationship or the second degree relationship regardless of an actual relationship between them.

9. The computer-implemented method of claim 7, wherein sending the tag with the first secret to the specified user includes:
confirming, by the server computer, that a first number of friends the specified user has in the social networking application satisfies a second propagation policy, and
sending the relationship information of a first type with the first secret, the first type indicating that the specified user has a first degree relationship with the first user.

10. The computer-implemented method of claim 7, wherein sending the tag with the first secret to the specified user includes:
confirming, by the server computer, that a first number of friends the specified user has in the social networking application does not satisfy a second propagation policy, and
sending the relationship information of a third type with the first secret, the third type indicating that the specified user has either a first degree or a second degree relationship with the first user.

11. (canceled)

12. The computer-implemented method of claim 1 further comprising:
sending, by the server computer, a plurality of secrets corresponding to the messages of the social networking application to the first user: and
for each of the secrets,
sending a tag with a specified secret, the tag including (a) a relationship information of the first user with a specified user of the users who posted the specified secret or (b) a location information of the specified user.

13. The computer-implemented method of claim 12, wherein sending the tag with the specified secret includes:
determining, by the server computer, whether the specified user who posted the specified secret is one of the friends of the first user, a second friend of the one of the friends (“FoF”) or other than the one of the friends and the FoF,
if the specified user is the one of the friends or the FoF, sending the relationship information in the tag, and
if the specified user is other than the one of the friends and the FoF, sending the location information in the tag.

14. The computer-implemented method of claim 13, wherein sending the relationship information in the tag with the specified secret includes:
confirming, by the server computer, that a first number of the friends of the first user satisfies a second propagation policy,
sending the relationship information of:
a first type if the specified user is the one of the friends, or
a second type if the specified user is the FoF.

15. The computer-implemented method of claim 14, wherein the relationship information of the first type indicates that the specified user and the first user share a first degree relationship, and wherein the relationship information of the second type indicates that the specified user and the first user share a second degree relationship.

16. The computer-implemented method of claim 13, wherein sending the relationship information in the tag with the specified secret includes:
confirming, by the server computer, that a first number of the friends of the first user does not satisfy a second propagation policy, and
sending the relationship information of a third type.

17. (canceled)

18. The computer-implemented method of claim 1, wherein the comparing includes:
instructing, by the server computer, the portion of the social networking application executing at the computing device to hash contact information of the contacts in the address book of the first user to generate the first set of hashed contact information, and
receiving, at the server computer and from the computing device, the first set of hashed contact information.

19. A server computer for sharing a plurality of messages posted by a plurality of users in a social networking application, the server computer comprising:
a processor;
a memory storing instructions, which when executed by the processor, cause the processor to perform a method including:
receiving the messages from the users, wherein the messages includes a given message posted by a given user of the users, the given message including multimedia content that is input by the given user, wherein the given message is generated using a portion of the social networking application executing on a computing device associated with the given user;
anonymizing the messages to generate corresponding plurality of secrets, the anonymizing including removing, from the messages, user identification information that determines or is used to determine an identity of the users;
determining one or more of the secrets to be transmitted to a first user of the users based on a first propagation policy; and
transmitting the one or more of the secrets to a first computing device associated with the first user.

20. The server computer of claim 19, wherein determining the one or more of the secrets to be transmitted based on the first propagation policy includes:
determining a plurality of friends of the first user, the friends being a set of the users whose contact information stored at the server computer match with contact information of a plurality of contacts in an address book of the first user,
determining whether a first number of the friends satisfies the first propagation policy, and
responsive to a determination that the first number of the friends satisfies the first propagation policy, including at least a first set of the secrets posted by one or more of the friends in the one or more of the secrets.

21. The server computer of claim 20, wherein determining the one or more of the secrets to be transmitted based on the first propagation policy further includes:
responsive to a determination that the first number of the friends does not satisfy the first propagation policy, excluding the first set of the secrets from the one or more of the secrets transmitted to the first user.

22. The server computer of claim 20, wherein transmitting the one or more of the secrets to the first user further includes:
for each of the one or more of the secrets,
sending relationship information with a specified secret, the relationship information indicating a relationship between the first user and a specified user of the users who posted the specified secret.

23. The server computer of claim 22, wherein sending the relationship information with the specified secret includes:
confirming that the first number of the friends satisfies a second propagation policy, and
sending the relationship information of:
a first type, the first type indicating that the first user and the specified user share a first degree relationship if the specified user is one of the friends, or
a second type, the second type indicating that the first user and the specified user share a second degree relationship if the specified user is a friend of one of the friends of the first user (“FoF”).

24. The server computer of claim 22, wherein sending the relationship information with the specified secret includes:
confirming that the first number of the friends does not satisfy a second propagation policy, and
sending the relationship information of a third type, the third type indicating that the first user and the specified user share a first degree relationship or a second degree relationship, regardless of whether the specified user is one of the friends or the FoF.

25. The server computer of claim 20, wherein determining the friends of the first user includes:
generating a friend graph object of the first user, the friend graph object containing user information of the friends of the first user, the generating including:
obtaining hashed contact information of the contacts in the address book of the first user,
comparing the hashed contact information of the contacts with hashed contact information of the users to determine a match with the set of the users, and
storing the user information of the set of the users in the friend graph object.

26. The server computer of claim 19, wherein the one or more of the secrets includes at least a first set of the secrets posted by a first friend of a second friend of the first user, the second friend of the first user being one of the users who shares a first degree relationship with the first user, the first friend being one of the users who shares a second degree relationship with the first user.

27. The server computer of claim 19, wherein transmitting the one or more of the secrets includes transmitting a plurality of comments posted on a first secret of the one or more of the secrets to the first user.

28. (canceled)

29. A computing device for facilitating sharing of a plurality of messages in a social networking application, comprising:
a processor;
a memory storing instructions, which when executed by the processor, cause the processor to perform a method including:
receiving, from a server computer, a plurality of secrets corresponding to the messages posted by a plurality of users of the social networking application, wherein the messages includes a first message posted by a first user of the users, the first message including multimedia content that is input by the first user, wherein the secrets includes a first secret that is generated, by the server computer, from the first message, the first secret generated by removing user identification information that determines or is used to determine an identity of the first user from the first message, wherein the users generate the messages using a portion of the social networking application executing on computing devices associated with the users, the computing device associated with a specified user of the users;
receiving, from the server computer, a plurality of tags associated with the secrets, wherein the tags include a first tag associated with the first secret, the first tag including at least one of (a) a relationship information of the specified user with the first user or (b) a location information of the first user; and
receiving, from the server computer, a first set of instructions for displaying the secrets at the computing device.

30. The computing device of claim 29, wherein receiving the first set of instructions for displaying the secrets further includes:
displaying the secrets as a plurality of secret components, wherein the secret components includes a first secret component that displays the first secret, the first secret component displaying the first secret as a combination of a text of the first secret and one of a background color or an image of the first secret.

31. The computing device of claim 30, wherein displaying the first secret further includes:
displaying the first secret by superimposing the text on one of the background color or the image, the text forming a foreground of the first secret component and the background color or the image forming the background of the first secret component.

32. The computing device of claim 30, wherein displaying the first secret further includes:
displaying information regarding (a) a number of “loves” and (b) a number of comments received on the first secret in the first secret component.

33. The computing device of claim 29, wherein the memory further includes instructions for performing the method of:
receiving, at the computing device, a message from the specified user to be posted to the social networking application, the message including a text and one of a background color or an image, and
transmitting, by the computing device, the message to the server computer to be shared with one or more of the users as a secret.
